(19) United States
(12) Patent Application Publication
(10) Pub. No.: US 2026/0084191 A1
(43) Pub. Date: Mar. 26, 2026

(54) SUBSTRATE PROCESSING APPARATUS AND SUBSTRATE PROCESSING METHOD

(71) Applicant: Kioxia Corporation, Tokyo (JP)

(72) Inventors: Mana TANABE, Yokohama Kanagawa (JP); Kosuke TAKAI, Yokohama Kanagawa (JP); Ryoji YOSHIKAWA, Yokohama Kanagawa (JP); Kaori UMEZAWA, Fujisawa Kanagawa (JP); Kenji MASUI, Kawasaki Kanagawa (JP)

(73) Assignee: Kioxia Corporation, Tokyo (JP)

(21) Appl. No.: 19/049,801

(22) Filed: Feb. 10, 2025

(30) Foreign Application Priority Data
Sep. 26, 2024 (JP) 2024-166849

(51) Int. Cl. B08B 7/00; B08B 3/10; B08B 7/02; B08B 13/00

(52) U.S. Cl. CPC B08B 7/0014; B08B 3/10; B08B 7/0092; B08B 7/02; B08B 13/00

(57) ABSTRACT

A substrate processing apparatus includes a substrate holder to hold a substrate, a treatment liquid supplier to supply a treatment liquid onto a surface of the substrate to be cleaned, a cooler to supply a cooling medium for cooling the substrate, an impactor to apply an impact to a treatment liquid layer, and a controller. The controller controls the cooler to cool the treatment liquid layer to a temperature lower than a freezing point, and controls the impactor to apply an impact to a starting point of forced freezing located away from a starting point of spontaneous freezing in the treatment liquid layer formed on the surface of the substrate to be cleaned, when a temperature of the treatment liquid layer formed reaches a set temperature that is lower than a freezing point and higher than a temperature at which spontaneous freezing occurs.

### CROSS-REFERENCE TO RELATED APPLICATION

This application is based upon and claims the benefit of priority from Japanese Patent Application No. 2024-166849, filed Sep. 26, 2024, the entire contents of which are incorporated herein by reference.

### FIELD

Embodiments described herein relate generally to a substrate processing apparatus and a substrate processing method.

### BACKGROUND

Freeze cleaning involves contacting a cooling medium with a rear surface of a substrate, solidifying a liquid film formed on a front surface of the substrate to form a frozen film, and then removing the frozen film to remove any foreign substance adhered to the front surface of the substrate. Here, the liquid film formed on the front surface of the substrate is cooled to a temperature equal to or lower than a freezing point, and spontaneously solidifies at a predetermined temperature to form the frozen film.

### DESCRIPTION OF THE DRAWINGS

FIG. 1 is a cross-sectional view schematically showing an example of a configuration of a substrate processing apparatus according to a first embodiment;

FIG. 2 is a top view schematically showing an example of the configuration of the substrate processing apparatus;

FIG. 3 is a view showing an example of a procedure of a substrate processing method in the first embodiment;

FIG. 4 is a view showing an example of the procedure of the substrate processing method;

FIG. 5 is a view showing an example of the procedure of the substrate processing method;

FIG. 6 is a view showing an example of the procedure of the substrate processing method;

FIG. 7 is a view showing an example of the procedure of the substrate processing method;

FIG. 8 is a view showing an example of progress of freezing at the start of freezing of a treatment liquid layer in the first embodiment;

FIG. 9 is a view showing an example of the progress of freezing at the start of freezing in the treatment liquid layer;

FIG. 10 is a flowchart showing an example of a procedure of freeze cleaning in the first embodiment;

FIG. 11 is a view showing an example of progress of freezing at the start of freezing of a treatment liquid layer in a comparative example;

FIG. 12 is a view showing an example of the progress of freezing at the start of freezing in the treatment liquid layer;

FIG. 13 is a cross-sectional view schematically showing an example of a configuration of a substrate processing apparatus according to a second embodiment;

FIG. 14 is a top view schematically showing an example of the configuration of the substrate processing apparatus;

FIG. 15 is a view showing an example of a procedure of a substrate processing method in the second embodiment;

FIG. 16 is a cross-sectional view schematically showing an example of a configuration of a substrate processing apparatus according to a third embodiment;

FIG. 17 is a top view schematically showing an example of the configuration of the substrate processing apparatus;

FIG. 18 is a view showing an example of a procedure of a substrate processing method in the third embodiment;

FIG. 19 is a view showing an example of the procedure of the substrate processing method;

FIG. 20 is a view showing an example of the procedure of the substrate processing method;

FIG. 21 is a view showing an example of the procedure of the substrate processing method;

FIG. 22 is a view showing an example of the procedure of the substrate processing method;

FIG. 23 is a cross-sectional view schematically showing an example of a configuration of a substrate processing apparatus according to a fourth embodiment;

FIG. 24 is a top view schematically showing an example of the configuration of the substrate processing apparatus;

FIG. 25 is a view showing an example of a procedure of a substrate processing method in the fourth embodiment;

FIG. 26 is a view showing an example of a procedure of the substrate processing method;

FIG. 27 is a view showing an example of a procedure of the substrate processing method;

FIG. 28 is a view showing an example of a procedure of the substrate processing method;

FIG. 29 is a view showing an example of a procedure of the substrate processing method;

FIG. 30 is a cross-sectional view schematically showing an example of a configuration of a substrate processing apparatus according to a fifth embodiment;

FIG. 31 is a top view schematically showing an example of the configuration of the substrate processing apparatus;

FIG. 32 is a diagram of an ultrasonic oscillator in the substrate processing apparatus;

FIG. 33 is a view showing an example of a procedure of a substrate processing method in the fifth embodiment;

FIG. 34 is a view showing an example of the procedure of the substrate processing method;

FIG. 35 is a view showing an example of the procedure of the substrate processing method;

FIG. 36 is a view showing an example of the procedure of the substrate processing method;

FIG. 37 is a view showing an example of the procedure of the substrate processing method;

FIG. 38 is a cross-sectional view schematically showing an example of a configuration of a substrate processing apparatus according to a sixth embodiment;

FIG. 39 is a top view schematically showing an example of the configuration of the substrate processing apparatus according;

FIG. 40 is a view showing an example of a procedure of a substrate processing method in the sixth embodiment;

FIG. 41 is a view showing an example of the procedure of the substrate processing method;

FIG. 42 is a view showing an example of the procedure of the substrate processing method;

FIG. 43 is a view showing an example of the procedure of the substrate processing method;

FIG. 44 is a view showing an example of the procedure of the substrate processing method;

FIG. 45 is a cross-sectional view schematically showing an example of a configuration of a substrate processing apparatus according to a seventh embodiment;

FIG. 46 is a cross-sectional view schematically showing an example of a configuration of a substrate processing apparatus according to an eighth embodiment;

FIG. 47 is a flowchart showing an example of a procedure of freeze cleaning in the eighth embodiment; and

FIG. 48 is a top view schematically showing an example of a configuration of a substrate processing apparatus according to a ninth embodiment.

### DETAILED DESCRIPTION

Embodiments provide a substrate processing apparatus and a substrate processing method capable of improving a removal rate of a foreign substance (foreign matter) adhered to a substrate.

In general, according to one embodiment, a substrate processing apparatus of an embodiment includes: a substrate holder that holds a substrate; a treatment liquid supply unit that supplies a treatment liquid onto a surface to be cleaned of the substrate; a solidification unit that supplies a cooling medium for cooling the substrate; an impact application unit capable of applying an impact to a treatment liquid layer formed on the surface to be cleaned of the substrate; and a control unit that controls the treatment liquid supply unit, the solidification unit, and the impact application unit. The control unit controls the solidification unit to cool the treatment liquid layer formed on the surface to be cleaned of the substrate to a temperature lower than a freezing point to bring the treatment liquid layer to a supercooled state, and controls the impact application unit to apply an impact to a starting point of forced freezing located away from a starting point of spontaneous freezing in the treatment liquid layer formed on the surface to be cleaned of the substrate, when a temperature of the treatment liquid layer formed on the surface to be cleaned of the substrate reaches a set temperature that is lower than a freezing point and higher than a temperature at which spontaneous freezing occurs.

Hereinafter, embodiments of the present disclosure will be described with reference to the drawings. The present disclosure is not limited to the embodiments. The drawings are schematic or conceptual, and proportions of various components are not necessarily the same as actual proportions. In the specification and drawings, elements similar to those described above with reference to the previous drawings are given the same reference numerals, and detailed descriptions thereof will be omitted as appropriate.

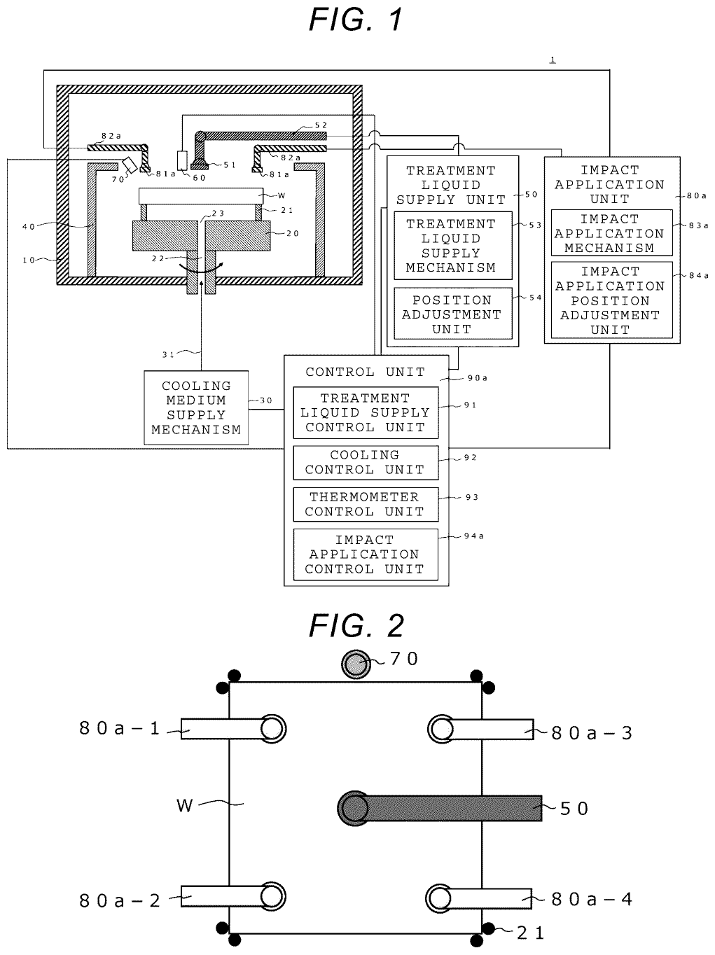

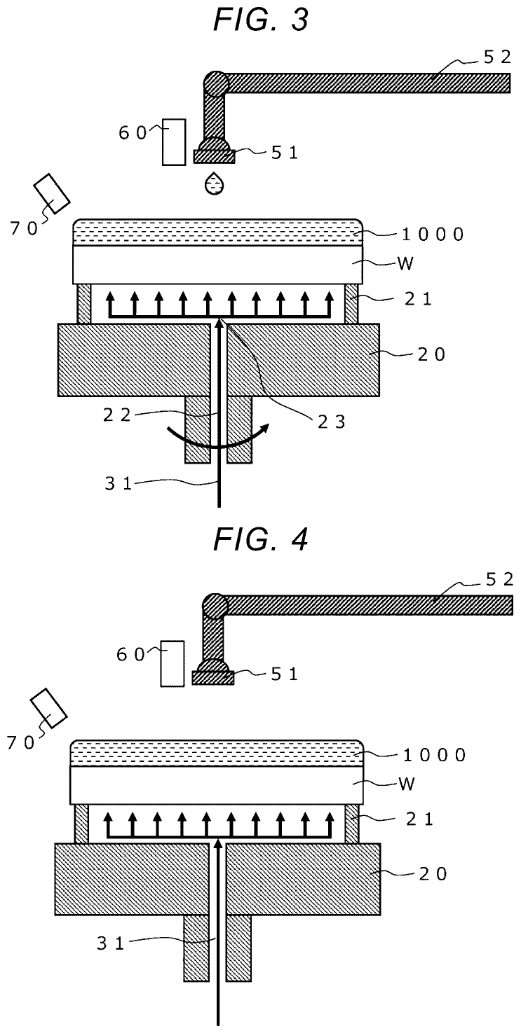

(First Embodiment) FIG. 1 is a cross-sectional view schematically showing an example of a configuration of a substrate processing apparatus 1 according to a first embodiment. FIG. 2 is a top view schematically showing an example of the configuration of the substrate processing apparatus 1 according to the first embodiment. FIGS. 3 to 7 are views showing an example of procedures of a substrate processing method in the first embodiment. The substrate processing apparatus 1 includes a chamber 10, a stage 20, a cooling medium supply mechanism (a cooler, a solidifier) 30, a cleaning cup 40, a treatment liquid supply unit (a treatment liquid supplier, a treatment liquid source) 50, a radiation thermometer 60, a thermometer 70, an impact application unit (impactor) 80a, and a control unit (controller) 90a.

The chamber 10 is, for example, a rectangular or cylindrical container, into which a substrate W to be subjected to freeze cleaning can be loaded and unloaded.

The stage 20 holds the substrate W. The stage 20 corresponds to a substrate holder. The stage 20 is provided with a support portion 21 that supports the substrate W at a position higher than an upper surface of the stage 20. The support portion 21 supports the substrate W spaced from the upper surface of the stage 20 such that a cooling medium (coolant) 31 to be described later comes into contact with a rear surface, that is, a lower surface of the substrate W. When the substrate W is supported by the stage 20, the substrate W may be supported such that a surface to be cleaned of the substrate W is a front surface, that is, an upper surface. The support portion 21 extends vertically from the upper surface of the stage 20 and comes into contact with a part of a side surface or the lower surface of the substrate W to support the substrate W. For example, a plurality of pin-shaped support portions 21 are provided on the upper surface of the stage 20. When the substrate W has a quadrilateral shape, the support portions 21 may be provided at four locations on the upper surface of the stage 20 to support four end portions of the substrate W. A case where the support portions 21 are provided at four locations on the upper surface of the stage 20 will be described below.

A through hole 22 that passes through the stage 20 vertically is provided near the center of the stage 20 in a horizontal direction. The through hole 22 extends from the upper surface of the stage 20 in a vertical direction opposite to the extension direction of the support portion 21, and passes through the stage 20. A portion where the through hole 22 intersects with the upper surface of the stage 20 is a supply port 23 for the cooling medium 31. The through hole 22 of the stage 20 is connected to the cooling medium supply mechanism 30, and the cooling medium 31 supplied from the cooling medium supply mechanism 30 is supplied to a rear surface of the surface to be cleaned of the substrate W through the through hole 22.

The stage 20 may be rotatable about an axis perpendicular to a surface on which a substrate can be placed. The axis may pass through the center of the surface on which the substrate W can be placed. When the stage 20 is rotatable, the support portion 21 may be provided with a stopper that prevents the substrate W from moving in the horizontal direction due to the rotation of the stage 20. When the stage 20 is rotatable, the stage 20 may be provided with a rotation mechanism, and the rotation mechanism may be controlled by the control unit 90a.

The cooling medium supply mechanism 30 supplies the cooling medium 31 for cooling a treatment liquid layer formed on the surface to be cleaned of the substrate W during freeze cleaning to a temperature equal to or lower than a freezing point of a treatment liquid. The cooling medium supply mechanism 30 includes, for example, a cooling medium storage unit, a cooling medium pipe, and a valve, which are not shown. The cooling medium storage unit stores the cooling medium 31. The cooling medium pipe connects the cooling medium storage unit to the through hole 22 of the stage 20. Regarding supply of the cooling medium 31, the valve switches supply of the cooling medium 31 on and off. The cooling medium supply mechanism 30 corresponds to a solidification unit.

The cooling medium supply mechanism 30 is connected to the stage 20 via the through hole 22, and supplies the cooling medium 31 toward the rear surface of the substrate W through the through hole 22. Thus, the cooling medium 31 is supplied from the supply port 23 into the chamber 10 through the through hole 22, and contacts the rear surface of the surface to be cleaned of the substrate W to cool the substrate W and the treatment liquid layer formed on the substrate W. The through hole 22 is provided near the center of the stage 20 when viewed from above, and the cooling medium 31 supplied from the cooling medium supply mechanism 30 is supplied toward the center of the rear surface of the substrate W. In other words, the rear surface of the substrate W is cooled first at the center, and then gradually cooled toward end portions.

A position at which the cooling medium 31 is supplied from the cooling medium supply mechanism 30 to the rear surface of the substrate W may not be the center of the rear surface of the substrate W. Here, the substrate W is first cooled from a portion supplied with the cooling medium 31, and then gradually cooled toward periphery thereof.

The cooling medium 31 supplied from the cooling medium supply mechanism 30 may be, for example, a gas such as nitrogen gas cooled to a temperature lower than the freezing point of the treatment liquid supplied to the surface to be cleaned of the substrate W, or a liquid such as liquid nitrogen or liquid fluorocarbon.

The cleaning cup 40 is provided in the chamber 10. The shape of the cleaning cup 40 may be, for example, cylindrical. The stage 20 is accommodated in the cleaning cup 40.

The treatment liquid supply unit 50 includes a nozzle 51 for dropping the treatment liquid onto the surface to be cleaned of the substrate W, a nozzle head 52, a treatment liquid supply mechanism 53, and a position adjustment unit 54.

The nozzle 51 and the nozzle head 52 are disposed above the substrate W, are used for freeze cleaning, and supply the treatment liquid onto the surface to be cleaned of the substrate W. The treatment liquid is, for example, pure water or deionized water. A supply port of the nozzle 51 may be located above and near the center of the substrate W. Hereinafter, a case will be described in which the nozzle 51 of the treatment liquid supply unit 50 is provided above the center of the substrate W placed on the stage 20 and pure water is supplied as the treatment liquid. The center refers to, for example, the center of the substrate W and vicinity thereof.

The nozzle 51 and the nozzle head 52 are connected to the treatment liquid supply mechanism 53 via a treatment liquid pipe (not shown). That is, the treatment liquid pipe (not shown) connects the nozzle 51 to the treatment liquid supply mechanism 53. The treatment liquid supply unit 50 may be provided to be movable horizontally or vertically by the position adjustment unit 54, or may be fixed near the center of the stage 20. The treatment liquid supply unit 50 may be provided to be rotatable.

The treatment liquid supply mechanism 53 includes, for example, a treatment liquid storage unit (not shown) for storing the treatment liquid, a treatment liquid pipe (not shown), a pump (not shown), and a valve (not shown). The treatment liquid storage unit stores the treatment liquid to be supplied onto the substrate W. The treatment liquid storage unit stores, for example, pure water. The treatment liquid pipe connects the nozzle head 52 to the treatment liquid storage unit. The pump sends the treatment liquid from the treatment liquid storage unit to the nozzle 51 via the treatment liquid pipe. Regarding supply of the treatment liquid from the treatment liquid storage unit to the nozzle 51, the valve switches the supply of the treatment liquid on and off.

The position adjustment unit 54 can drive the nozzle 51 or the nozzle head 52 horizontally or vertically. The position adjustment unit 54 drives the nozzle 51 and the nozzle head 52 under the control of a treatment liquid supply control unit 91 which will be described later.

The radiation thermometer 60 measures a temperature of the center of the treatment liquid layer formed on the substrate W. The radiation thermometer 60 is provided as a first thermometer.

The radiation thermometer 60 may be built in the nozzle 51 or the nozzle head 52 of the treatment liquid supply unit 50, or may be provided separately from the treatment liquid supply unit 50. When the radiation thermometer 60 is built in the nozzle 51 or the nozzle head 52 of the treatment liquid supply unit 50, the radiation thermometer 60 is driven in conjunction with the treatment liquid supply unit 50 being driven horizontally or vertically by the position adjustment unit 54. When the radiation thermometer 60 is provided separately from the treatment liquid supply unit 50, the radiation thermometer 60 may have a driving mechanism (not shown) and be driven above the substrate W horizontally or vertically.

The radiation thermometer 60 may measure the temperature at the center of the substrate W to estimate the temperature at the center of a treatment liquid layer 1000. This is because the temperature of the center of the treatment liquid layer 1000 is reflected on the substrate W. Such an indirect measurement method also includes the meaning that “the radiation thermometer 60 measures the temperature at the center of the treatment liquid layer formed on the substrate W”.

Information on the temperature measured by the radiation thermometer 60 is transmitted to the control unit 90a, which will be described later. Hereinafter, a case where the radiation thermometer 60 is built in the treatment liquid supply unit 50 will be described.

The thermometer 70 measures a temperature distribution of the treatment liquid layer 1000 formed on the substrate W, which will be described later. The thermometer 70 is provided as a second thermometer.

The thermometer 70 is provided with a driving mechanism (not shown) and may be movable horizontally or vertically above the substrate W by the driving mechanism, or may be fixed at a predetermined position.

The thermometer 70 may measure a temperature distribution of the substrate W to estimate the temperature distribution of the treatment liquid layer. Such an indirect measurement method also includes the meaning that “the thermometer 70 measures the temperature distribution of the treatment liquid layer formed on the substrate W”.

Information on the temperature measured by the thermometer 70 is transmitted to the control unit 90a, which will be described later.

When temperature distribution information on the substrate W and the treatment liquid layer is recorded in hardware, software, or the like, the radiation thermometer 60 and the thermometer 70 may not be provided. Here, the hardware or the software are capable of storing information such as temperature change over time in the treatment liquid layer formed on the substrate W and a temperature distribution of the treatment liquid layer, and may give instructions to the impact application unit 80a described later at a predetermined timing. The substrate processing apparatus 1 without the radiation thermometer 60 and the thermometer 70 will be described in detail in seventh and eighth embodiments.

The impact application unit 80a includes a nozzle 81a, a nozzle head 82a, an impact application mechanism 83a, and an impact application position adjustment unit 84a. The impact application unit 80a is provided as a liquid supply unit (a liquid supplier, a liquid source).

The impact application unit 80a moves horizontally or vertically to a location having high temperature in the substrate W based on the temperature measured by the thermometer 70, and applies an impact to a predetermined location of the treatment liquid layer formed on the substrate W. The predetermined location is, for example, a location having high temperature in the treatment liquid layer. Here, a plurality of impact application units 80a may be provided. By moving the impact application units 80a to a plurality of locations on the surface to be cleaned of the substrate W, impacts can be applied to a plurality of locations in the substrate W simultaneously. In the present embodiment, an impact is applied to the treatment liquid layer by dropping droplets of liquid onto the treatment liquid layer.

One impact application unit 80a provided with a plurality of sets of the nozzle 81a and the nozzle head 82a may be provided, or a plurality of impact application units 80a each provided with one set of the nozzle 81a and the nozzle head 82a may be provided. When a plurality of impact application units 80a are provided, for example, four impact application units 80a are provided above the substrate W. Here, when the nozzle 81a and the nozzle head 82a are regarded as one set, four sets of the nozzle 81a and the nozzle head 82a are provided above the substrate W. The impact application mechanism 83a and the impact application position adjustment unit 84a may be provided for each impact application unit 80a, or one impact application mechanism 83a and one impact application position adjustment unit 84a may be shared by a plurality of impact application units 80a. The plurality of impact application units 80a may share one of the impact application mechanism 83a or the impact application position adjustment unit 84a, and the other may be provided for each of the plurality of impact application units 80a.

A case where four impact application units 80a are provided, such as 80a-1, 80a-2, 80a-3, and 80a-4, will be described below. The impact application units 80a-1, 80a-2, 80a-3, and 80a-4 may be collectively referred to as the impact application unit 80a.

After the treatment liquid layer 1000 is formed on the substrate W, the impact application unit 80a applies an impact to the treatment liquid layer 1000 when the control unit 90a determines that the temperature measured by the radiation thermometer 60 is equal to or lower than the set temperature. The nozzle 81a and the nozzle head 82a of the impact application unit 80a are disposed above the treatment liquid layer 1000 to supply the liquid. Here, the liquid supplied from the nozzle 81a may be the same as the treatment liquid supplied from the treatment liquid supply unit 50, or may be a different liquid. When the liquid supplied from the nozzle 81a is the same as the treatment liquid supplied from the treatment liquid supply unit 50, the nozzle 81a supplies the treatment liquid onto the treatment liquid layer 1000 formed on the substrate W. A case where the treatment liquid is supplied from the impact application mechanism 83a will be described below.

The nozzle 81a and the nozzle head 82a are connected to the impact application mechanism 83a via a treatment liquid pipe (not shown). That is, the treatment liquid pipe (not shown) connects the nozzle head 82a to the impact application mechanism 83a.

The impact application mechanism 83a includes, for example, a treatment liquid storage unit that stores the treatment liquid, a treatment liquid pipe, a pump, and a valve, which are not shown. The treatment liquid storage unit stores the treatment liquid to be supplied onto the treatment liquid layer 1000. The treatment liquid storage unit stores, for example, pure water. The treatment liquid pipe connects the nozzle head 82a to the treatment liquid storage unit. The pump sends the treatment liquid from the treatment liquid storage unit to the nozzle 81a via the treatment liquid pipe. Regarding supply of the treatment liquid from the treatment liquid storage unit to the nozzle 81a, the valve switches the supply of the treatment liquid on and off.

The treatment liquid storage unit in the impact application mechanism 83a may be provided separately for each of the impact application units 80a-1, 80a-2, 80a-3, and 80a-4, or may be shared by the impact application units 80a-1, 80a-2, 80a-3, and 80a-4. The treatment liquid supply mechanism 53 and the impact application mechanism 83a may share the treatment liquid storage unit.

The impact application position adjustment unit 84a can drive the nozzle 81a or the nozzle head 82a horizontally or vertically. The impact application units 80a-1, 80a-2, 80a-3, and 80a-4 can be driven independently by the impact application position adjustment unit 84a. The impact application position adjustment unit 84a is controlled by an impact application control unit 94a to be described later, and controls the nozzle 81a or the nozzle head 82a. Here, the impact application position adjustment units 84a may be provided independently and driven separately in the impact application units 80a-1, 80a-2, 80a-3, and 80a-4. In other words, the impact application position adjustment units 84a may be provided in each of the impact application units 80a-1, 80a-2, 80a-3, and 80a-4, and the impact application units 80a-1, 80a-2, 80a-3, and 80a-4 may be driven individually by the respective impact application position adjustment units 84a.

The control unit 90a controls the overall operation of the substrate processing apparatus 1 according to a recipe. The control unit 90a includes the treatment liquid supply control unit 91, a cooling control unit 92, a thermometer control unit 93, and the impact application control unit 94a.

The treatment liquid supply control unit 91 controls a dropping position and a dropping amount of the treatment liquid onto the substrate W during freeze cleaning. The treatment liquid supply control unit 91 drops the treatment liquid from the treatment liquid supply unit 50 to form the treatment liquid layer 1000, such that a solidified layer 1010 to be described later in which the treatment liquid is solidified over the entire surface of the substrate W is formed. When supplying the treatment liquid, the treatment liquid supply unit 50 may be driven to the center of the substrate W by the position adjustment unit 54. In other words, the treatment liquid supply control unit 91 instructs the driving mechanism such that the nozzle 51 is disposed at the position of the center of the substrate W. In the present specification, “to solidify” may be expressed as “to freeze”.

The cooling control unit 92 controls the on/off switching of the supply of the cooling medium 31 during freeze cleaning. The control is performed, for example, by controlling opening and closing of the valve of the cooling medium supply mechanism 30 (not shown).

The thermometer control unit 93 controls the radiation thermometer 60 and the thermometer 70 which measure the temperature of the treatment liquid layer 1000 formed on the surface to be cleaned of the substrate W. The thermometer control unit 93 receives information on the temperature of the treatment liquid layer 1000 measured by the radiation thermometer 60 and the thermometer 70, and displays the temperature distribution of the treatment liquid layer 1000 on a display unit (not shown) or the like. The received temperature information can be transmitted to the impact application control unit 94a to be described later.

When the thermometer 70 is provided with a driving mechanism (not shown), the thermometer 70 can be driven in the chamber 10, and the thermometer control unit 93 controls the driving mechanism to drive the thermometer 70.

The impact application control unit 94a controls the dropping position and the dropping amount of the treatment liquid from the impact application unit 80a. The impact application control unit 94a controls the impact application position adjustment unit 84a based on the temperature information on the treatment liquid layer 1000 from the thermometer control unit 93, and disposes the nozzle 81a above the treatment liquid layer 1000. Here, the impact application unit 80a is driven by the impact application position adjustment unit 84a to a location having high temperature in the treatment liquid layer 1000. In other words, the thermometer control unit 93 transmits the temperature information on the treatment liquid layer 1000 obtained by the thermometer 70 to the impact application control unit 94a. The impact application control unit 94a controls the impact application position adjustment unit 84a based on the received temperature information to dispose the nozzle 81a above a position having high temperature in the treatment liquid layer 1000. That is, the impact application control unit 94a controls the impact application position adjustment unit 84a such that the nozzle 81a is disposed at a location having high temperature in the treatment liquid layer 1000.

Here, when a plurality of impact application units 80a are provided (for example, the aforementioned impact application units 80a-1, 80a-2, 80a-3, and 80a-4), the impact application control unit 94a gives instructions to the impact application position adjustment unit 84a to dispose the impact application units 80a-1, 80a-2, 80a-3, and 80a-4 at a plurality of locations having high temperature in the treatment liquid layer, respectively. The impact application units 80a-1, 80a-2, 80a-3, and 80a-4 disposed above the treatment liquid layer 1000 drop the treatment liquid at a predetermined timing. Here, the impact application units 80a-1, 80a-2, 80a-3, and 80a-4 may simultaneously drop the treatment liquid.

Each element in the control unit 90a may be configured as either hardware or software. Each element in the control unit 90a may be provided independently, or a plurality of elements in the control unit 90a may be provided integrally.

FIG. 2 is a top view schematically showing an example of the configuration of the treatment liquid supply unit 50 and the impact application unit 80a disposed above the substrate W in the substrate processing apparatus 1 of the first embodiment. When the treatment liquid is supplied from the treatment liquid supply unit 50 disposed above the center of the substrate W, the treatment liquid layer 1000 is formed on the surface to be cleaned of the substrate W. The substrate W and the treatment liquid layer 1000 are cooled by the cooling medium 31 coming into contact with the surface of the substrate W opposite to the surface on which the treatment liquid layer 1000 is formed, that is, the rear surface. The temperature change of the treatment liquid layer is measured by the thermometer 70, and FIG. 2 shows a case where temperatures in four corners of the substrate W are high. Here, the impact application units 80a-1, 80a-2, 80a-3, and 80a-4 are disposed near the four corners of the treatment liquid layer, respectively.

Hereinafter, a case will be described in which the substrate W has a quadrilateral shape and the temperature of the treatment liquid layer 1000 formed near the four corners of an outer periphery of the substrate W is high.

Next, a freeze cleaning method using the substrate processing apparatus 1 of the first embodiment will be described. FIGS. 3 to 7 are views showing an example of procedures of a processing method of the substrate W in the first embodiment.

First, the substrate W is carried into the chamber 10 of the substrate processing apparatus 1. The substrate W is, for example, a template used in imprint lithography, a photomask used in photolithography, or a semiconductor substrate. A case where the substrate W has a quadrilateral shape will be described. The substrate W may have a shape other than a quadrilateral shape, such as a circle.

Next, as shown in FIG. 3, the substrate W to be processed is placed on the stage 20 with the surface to be cleaned facing up. Foreign substance is adhered to the surface to be cleaned of the substrate W. The substrate W is supported by the support portion 21 of the stage 20 such that a gap is formed between the stage 20 and the surface of the substrate W opposite to the surface to be cleaned. The support portion 21 may be movable in the vertical direction.

Next, the treatment liquid layer 1000 is formed on the upper surface of the substrate W. Here, the treatment liquid may be supplied from the nozzle 51 onto the surface to be cleaned of the substrate W and spread over the entire surface to be cleaned of the substrate W by a spin coating method, thereby forming the treatment liquid layer 1000. The treatment liquid may be pure water, deionized water, or the like. When the treatment liquid is spread over the entire surface to be cleaned of the substrate W, the stage 20 may rotate about the through hole 22 as an axis.

When the treatment liquid layer 1000 is formed, the cooling medium 31 is supplied from the cooling medium supply mechanism 30 to the surface of the substrate W opposite to the surface to be cleaned, that is, the rear surface. As the cooling medium, for example, a gas such as nitrogen gas cooled to a temperature lower than the freezing point of the treatment liquid, or a liquid such as liquid nitrogen or liquid fluorocarbon is used. The treatment liquid layer 1000 may be cooled by a method of cooling the treatment liquid layer 1000 by maintaining the inside of the chamber 10 at a low temperature, other than the method of discharging the cooling medium 31.

As shown in FIG. 4, the cooling medium 31 is supplied to the rear surface of the substrate W, thereby cooling the treatment liquid layer 1000.

The treatment liquid is, for example, pure water. The freezing point of pure water under 1 atmosphere is 0° C. Pure water remains in a liquid state even when the temperature drops below 0° C. under 1 atmosphere, that is, reaches a so-called supercooled state. In the present embodiment, the treatment liquid layer 1000 is cooled to a temperature lower than the freezing point of the treatment liquid. Thus, the treatment liquid layer 1000 reaches the supercooled state.

By supplying the cooling medium 31, the temperature of the treatment liquid layer 1000 is gradually lowered. The temperature of the treatment liquid layer 1000 becomes 0° C., that is, lower than the freezing point. In other words, the substrate W and the treatment liquid layer 1000 are cooled by supplying the cooling medium 31 cooled to a temperature equal to or lower than the freezing point of the treatment liquid, and the treatment liquid layer 1000 reaches the supercooled state.

In the present embodiment, the radiation thermometer 60 measures the temperature of the center of the treatment liquid layer 1000. The radiation thermometer 60 measures the temperature at the center of the treatment liquid layer 1000 and transmits the measurement result to the thermometer control unit 93. When the temperature of the center of the treatment liquid layer 1000 becomes equal to or lower than the set temperature, the thermometer control unit 93 notifies the impact application control unit 94a about the temperature.

The set temperature in the present embodiment is a temperature at which the treatment liquid layer 1000 in a supercooled state is solidified. The set temperature is set in a temperature range in which the treatment liquid layer 1000 becomes supercooled. A range of the set temperature is, for example, equal to or higher than −40° C. and equal to or lower than 0° C. under 1 atmosphere, which is higher than the temperature at which spontaneous freezing occurs. The spontaneous freezing refers to freezing in which a liquid spontaneously solidifies and turns into a solid when the temperature drops to a specific temperature after the liquid reaches the supercooled state. In other words, spontaneous freezing is freezing in which a supercooled liquid solidifies and becomes a solid without any impact being applied. Therefore, the set temperature in the present embodiment is a temperature immediately before the treatment liquid layer 1000 in a supercooled state spontaneously freezes, and is set to a temperature higher than a temperature at which spontaneous freezing occurs.

The thermometer 70 provided above the substrate W and the treatment liquid layer 1000 measures a temperature of the entire surface of the treatment liquid layer 1000. A temperature distribution of the entire surface of the treatment liquid layer 1000 measured by the thermometer 70 is transmitted to the thermometer control unit 93. When the temperature of the center of the treatment liquid layer 1000 becomes equal to or lower than the set temperature, the thermometer control unit 93 transmits location information on the location having high temperature in the treatment liquid layer 1000 to the impact application control unit 94a.

The cooling medium 31 is supplied toward the center of the rear surface of the substrate W, and gradually diffuses into the chamber 10 to cool the entire rear surface of the substrate W. In other words, the through hole 22 and the supply port 23 for supplying the cooling medium 31 into the chamber 10 are provided directly under a region including the center of the substrate W. Therefore, the cooling medium supplied from the through hole 22 and the supply port 23 is likely to come into contact with the center of the rear surface of the substrate W when the cooling medium diffuses from the supply port 23 into the chamber 10.

Here, the center of the substrate W is easily cooled, and the end of the substrate W is cooled slower than the center. Therefore, temperature unevenness occurs on the substrate W during cooling depending on locations. The treatment liquid layer 1000 may be cooled by maintaining the inside of the chamber 10 at a low temperature. Here, the location having high temperature in the substrate W may not necessarily occur at the end portion.

Hereinafter, a case will be described in which a location having high temperature in the substrate W and the treatment liquid layer 1000 formed on the substrate W occurs at the end portion when compared over the entire surface.

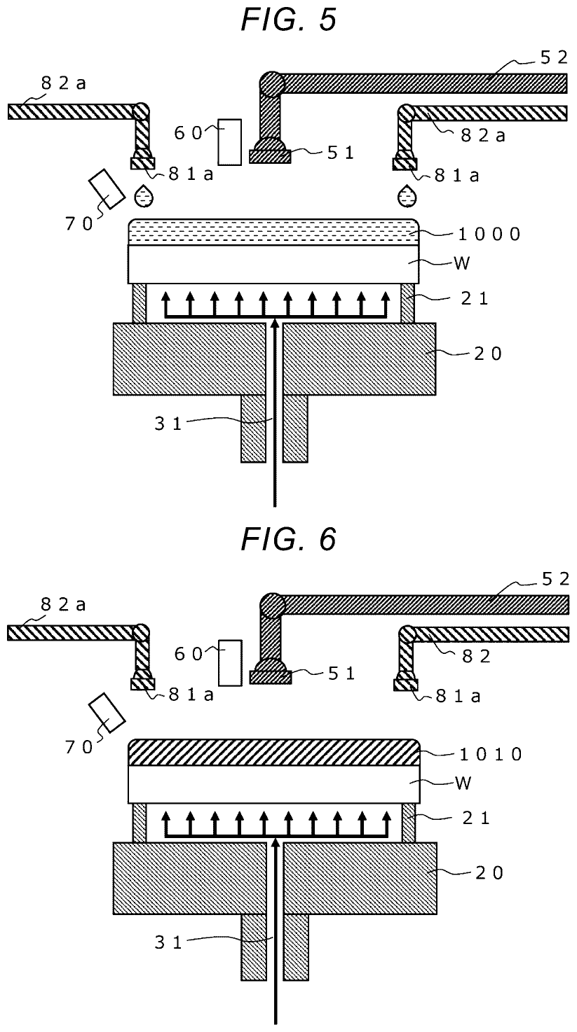

As shown in FIG. 5, when the temperature of the center of the treatment liquid layer 1000 reaches the set temperature, the impact application unit 80a drops (dispenses) droplets of the treatment liquid onto the location having high temperature in the treatment liquid layer 1000. Here, the temperature of the droplets dropped from the nozzle 81a may be, for example, equal to or lower than room temperature. The dropping amount of the droplets is an amount that the temperature of the treatment liquid layer 1000 at the dropped position can be maintained equal to or lower than the freezing point, and the dropping amount of the droplets is controlled by the impact application control unit 94a. The amount of the droplets supplied from the impact application unit 80a is, for example, 1 cc or less.

Due to the impact of the droplets dropped from the nozzle 81a coming into contact with the treatment liquid layer 1000, the treatment liquid layer 1000 starts to be forcibly frozen from a location of contact with the droplets. In the present embodiment, forced freezing refers to freezing in which solidification starts by applying an impact to a liquid in the supercooled state where the liquid remains in a liquid state even when the temperature becomes equal to or lower than the freezing point. In other words, forced freezing refers to applying an impact to the treatment liquid in the supercooled state to forcibly start solidification. Here, the location where the impact is applied and solidification starts forcibly is defined as a starting point of forced freezing.

In FIG. 4, the radiation thermometer 60 and the thermometer 70 which measure the temperature of the center and the entire surface of the treatment liquid layer 1000, respectively, transmit the measured temperatures to the thermometer control unit 93. When the radiation thermometer 60 detects that the center of the treatment liquid layer 1000 reaches a temperature equal to or lower than the set temperature, the thermometer control unit 93 transmits notification and location information on a plurality of locations having high temperature in the treatment liquid layer 1000 detected by the thermometer 70 to the impact application control unit 94a.

Accordingly, in FIG. 5, the impact application control unit 94a controls the impact application unit 80a based on the information from the thermometer control unit 93. Specifically, the impact application control unit 94a controls the impact application position adjustment unit 84a to drive the nozzle 81a and the nozzle head 82a. The impact application control unit 94a controls the impact application unit 80a to adjust the amount of droplets dropped from the nozzle 81a.

The nozzle head 82a is driven such that the position at which droplets are dropped from the nozzle 81a is disposed above a location having high temperature in the treatment liquid layer 1000. That is, the impact application units 80a-1, 80a-2, 80a-3, and 80a-4 are driven by the impact application position adjustment unit 84a such that the respective nozzles 81a are disposed above a plurality of locations having high temperature in the treatment liquid layer 1000. Thus, droplets are dropped onto the four locations having high temperature in the treatment liquid layer 1000 at approximately the same time.

Droplets are dropped from the nozzle 81a immediately before spontaneous freezing in the treatment liquid layer 1000 occurs. Therefore, when a part of the treatment liquid layer 1000 starts to solidify due to the impact of the droplets from the nozzle 81a coming into contact with the treatment liquid layer 1000, spontaneous freezing also occurs in the center of the treatment liquid layer 1000. Here, the location where spontaneous freezing starts is defined as a starting point of spontaneous freezing. In the present embodiment, the center of the treatment liquid layer 1000 is the starting point of spontaneous freezing.

FIG. 8 is a top view showing an example of progress of freezing at the start of freezing in the treatment liquid layer 1000 in the first embodiment. FIG. 9 is a cross-sectional view showing an example of the progress of freezing at the start of freezing in the treatment liquid layer 1000 in the first embodiment. FIGS. 8 and 9 show a case where spontaneous freezing occurs in the center of the treatment liquid layer 1000, and forced freezing occurs at four end portions of the treatment liquid layer 1000 by droplets dropped from the nozzle 81a.

By dropping droplets from the impact application units 80a-1, 80a-2, 80a-3, and 80a-4, starting points of freezing 1030A, 1030B, 1030C, and 1030D are generated at four end portions of the treatment liquid layer 1000, and forced freezing starts. Since forced freezing occurs due to the impact from the impact application units 80a-1, 80a-2, 80a-3, and 80a-4 immediately before spontaneous freezing occurs, spontaneous freezing occurs after forced freezing occurs. Spontaneous freezing occurs from a starting point of freezing 1040 which is the center of the substrate W and the treatment liquid layer 1000 where the temperature is lowest. The treatment liquid layer 1000 gradually solidifies from a plurality of starting points of freezing.

As shown in FIGS. 8 and 9, solidification is considered to progress radially from the starting points of freezing 1030 and 1040.

Next, as shown in FIG. 6, solidification of the treatment liquid layer 1000 progresses from the starting points of freezing 1030A, 1030B, 1030C, 1030D, and 1040 to form the solidified layer 1010. In other words, the treatment liquid layer 1000 solidifies to form the solidified layer 1010.

By applying an impact to the treatment liquid layer 1000 in a supercooled state, the treatment liquid layer 1000 undergoes a phase transition (solidification) and becomes solid from liquid. Here, the temperature of the treatment liquid layer 1000 returns to the freezing point. Thereafter, a temperature of the solidified layer 1010 drops again to be lower than the freezing point. The temperature of the solidified layer 1010 may be measured by the radiation thermometer 60.

When the treatment liquid layer 1000 solidifies into the solidified layer 1010, the treatment liquid between the foreign substance and the substrate W expands due to solidification, and the foreign substance receives an upward force. When the treatment liquid near the foreign substance is thawed in such state (e.g., so as to cause the treatment liquid to melt), the probability of the foreign substance moving upward increases.

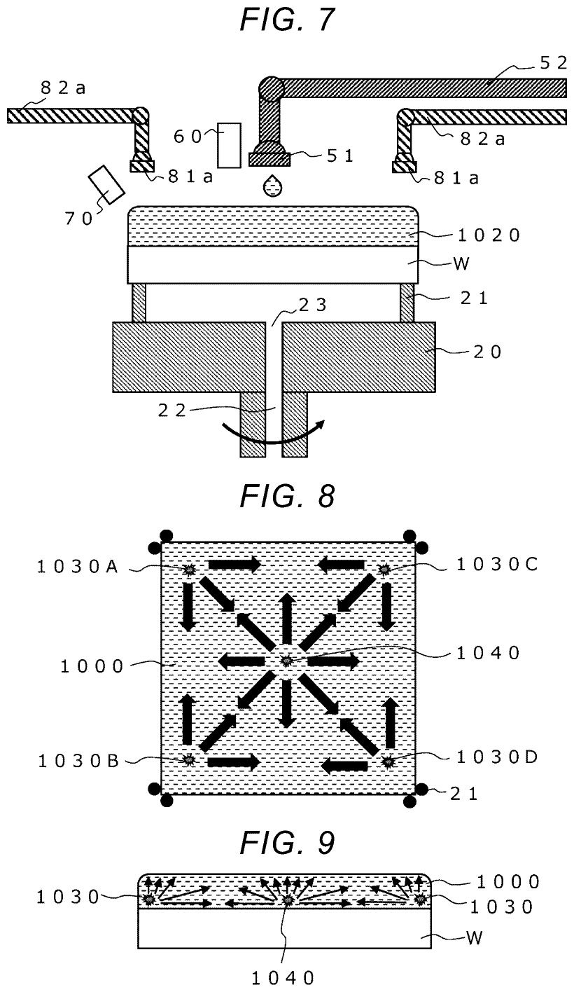

Next, as shown in FIG. 7, the supply of the cooling medium 31 to the lower surface of the substrate W is stopped, and the treatment liquid is supplied from the treatment liquid supply unit 50. Here, the treatment liquid to be supplied may be at room temperature. The solidified layer 1010 thaws to form a treatment liquid layer 1020.

Thus, the foreign substance that moved upward on the surface to be cleaned of the substrate W is washed away and removed by the treatment liquid. The above-described foreign substance removal process using solidification of liquid is called “freeze cleaning”.

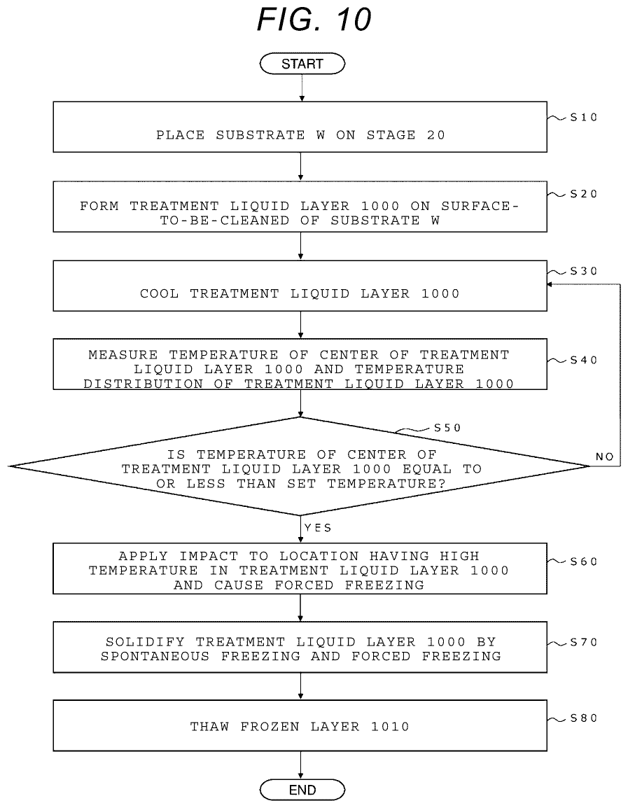

FIG. 10 is a flowchart showing an example of a procedure of freeze cleaning in the first embodiment.

First, the substrate W is carried into the chamber 10 of the substrate processing apparatus 1, and the substrate W to be processed is placed on the stage 20 (S10). Here, the substrate W is placed with the surface to be cleaned facing up. Foreign substance is adhered to the surface to be cleaned of the substrate W.

Next, the treatment liquid layer 1000 is formed on the upper surface of the substrate W (S20). The treatment liquid layer 1000 is formed on the surface to be cleaned of the substrate W by supplying the treatment liquid from the treatment liquid supply unit 50. Here, the treatment liquid layer 1000 may be formed by, for example, a spin coating method. When the treatment liquid layer 1000 is formed on the surface to be cleaned of the substrate W, the cooling medium 31 having a temperature lower than the freezing point of the treatment liquid may be supplied to the rear surface of the substrate W, that is, the surface opposite to the surface to be cleaned.

The treatment liquid layer 1000 is cooled by supplying the cooling medium 31 to the rear surface of the substrate W, and the treatment liquid layer 1000 reaches a supercooled state (S30). Here, the stage 20 may be rotated around the through hole 22 as an axis, or rotation may be stopped. Examples of the cooling medium include a gas such as nitrogen gas cooled to a temperature lower than the freezing point of the treatment liquid, or a liquid such as liquid nitrogen or liquid fluorocarbon.

During cooling of the substrate W and the treatment liquid layer 1000 by supplying the cooling medium 31, a thermometer provided above the treatment liquid layer 1000 measures the temperature of the treatment liquid layer 1000 (S40). The radiation thermometer 60 measures the temperature at the center of the treatment liquid layer 1000. The thermometer 70 measures the temperature of the entire surface of the treatment liquid layer 1000.

Next, the thermometer control unit 93 determines whether the temperature at the center of the treatment liquid layer 1000 is equal to or lower than a set temperature (S50). When the temperature at the center of the treatment liquid layer 1000 is equal to or lower than a set temperature (YES in S50), the impact application control unit 94a that receives, from the thermometer control unit 93, a notification that the center of the treatment liquid layer 1000 is equal to or lower than the set temperature and location information on a location having high temperature, controls the impact application unit 80a to apply an impact to the treatment liquid layer 1000, causing forced freezing (S60). Specifically, in the present embodiment, droplets are dropped onto a location having high temperature of the treatment liquid layer 1000. The position at which the droplets are dropped in the treatment liquid layer 1000 is determined based on the measurement result of the thermometer 70. When droplets are dropped onto the treatment liquid layer 1000, the stage 20 may be rotated around the through hole 22 as an axis. When the temperature of the center of the treatment liquid layer 1000 is higher than the set temperature (NO in S50), the substrate W and the treatment liquid layer 1000 are continuously cooled and the temperature measurement is performed.

When an impact is applied to the treatment liquid layer 1000, forced freezing in the treatment liquid layer 1000 starts (S60). Due to the impact of the droplets supplied from the nozzle 81a coming into contact with the treatment liquid layer 1000, the treatment liquid layer 1000 starts to be forcibly frozen from a location of contact with the droplets. Droplets are dropped from the nozzle 81a immediately before spontaneous freezing in the treatment liquid layer 1000 occurs. Therefore, when a part of the treatment liquid layer 1000 starts to solidify due to the impact of the droplets from the nozzle 81a coming into contact with the treatment liquid layer 1000, spontaneous freezing also occurs in the center of the treatment liquid layer 1000. In other words, forced freezing due to the impact of the droplets from the nozzle 81a coming into contact with the treatment liquid layer 1000 and spontaneous freezing in the center of the treatment liquid layer 1000 occur to solidify the treatment liquid layer 1000 (S70).

Next, the supply of the cooling medium 31 to the lower surface of the substrate W is stopped, and the stage 20 is rotated with the through hole 22 as an axis while the treatment liquid is supplied from the treatment liquid supply unit 50 to thaw the solidified layer 1010 (S80). Here, the treatment liquid to be supplied may be at room temperature.

By executing the above flow, foreign substance on the surface to be cleaned of the substrate W and covered by the treatment liquid layer 1000 is separated from the surface to be cleaned of the substrate W by an upward moving force and is removed.

As a comparative example, a case will be described in which spontaneous freezing occurs in a treatment liquid layer 1000′ that is formed on the substrate W and is in a supercooled state, without applying any impact.

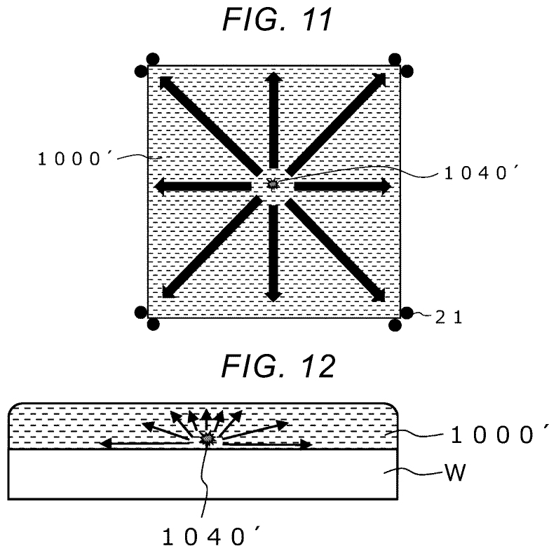

FIG. 11 is a top view showing an example of progress of freezing at the start of freezing of the treatment liquid layer 1000′ in the comparative example. FIG. 12 is a cross-sectional view showing an example of the progress of freezing at the start of freezing of the treatment liquid layer 1000′ in the comparative example. FIGS. 11 and 12 show a case where spontaneous freezing occurs in the center of the treatment liquid layer 1000′.

As described above, as shown in FIGS. 11 and 12, solidification is considered to progress radially from a starting point of freezing 1040′.

Therefore, as solidification progresses radially from the center of the treatment liquid layer 1000′, it is considered that a direction of growth into solid (solidification) becomes closer to a lateral direction as the distance from the starting point of freezing 1040′ increases, as shown in FIG. 12. Thus, at an end portion of the treatment liquid layer 1000′, the growth direction of solid is closer to the lateral direction than an upward direction. That is, the rate of upward expansion due to solidification of the end portion of the treatment liquid layer 1000′ is smaller than that of the center.

When the treatment liquid layer solidifies into the solidified layer, the treatment liquid between the foreign substance and the substrate W expands due to solidification, and the foreign substance receives an upward force. When the treatment liquid near the foreign substance is thawed in such state, the probability of the foreign substance moving upward increases. At the end portion of the treatment liquid layer 1000′, the force in the lateral direction is stronger than the force in the upward direction with respect to the growth direction of solid, such that the foreign substance is not likely to move upward, and the removal rate of the foreign substance is low.

In the present embodiment, as shown in FIGS. 8 and 9, at the timing when spontaneous freezing occurs, an impact is applied to a location having high temperature in the treatment liquid layer 1000, and forced freezing is performed. In other words, in the treatment liquid layer 1000 in a supercooled state, solidification occurs from the plurality of starting points of freezing 1030A, 1030B, 1030C, 1030D, and 1040 to form the solidified layer 1010.

Accordingly, in the treatment liquid layer 1000, the liquid expands upward into solid from the plurality of starting points of freezing 1030A, 1030B, 1030C, 1030D, and 1040. Therefore, there are fewer locations that expand laterally compared to the comparative example. Accordingly, even in a location far from the location of spontaneous freezing and having high temperature, the foreign substance is likely to receive an upward force, and the removal rate of the foreign substance on the substrate W is improved.

The starting points of freezing 1030A, 1030B, 1030C, and 1030D, that is, the starting points of forced freezing, may not be locations having high temperature in the treatment liquid layer 1000, and may be provided at positions different from the starting points of spontaneous freezing. In other words, the location in the treatment liquid layer 1000 where the impact is applied, which is the starting point of forced freezing, may be located away from the starting point of spontaneous freezing. For example, the starting point of forced freezing may be a location furthest from the starting point of freezing 1040, that is, the starting point of spontaneous freezing.

By measuring the temperatures of the entire substrate W and the entire treatment liquid layer 1000 with the thermometer 70, a temperature distribution can be measured with high accuracy. Therefore, it is possible to reliably apply an impact to the location having high temperature in the treatment liquid layer 1000, thereby causing forced freezing.

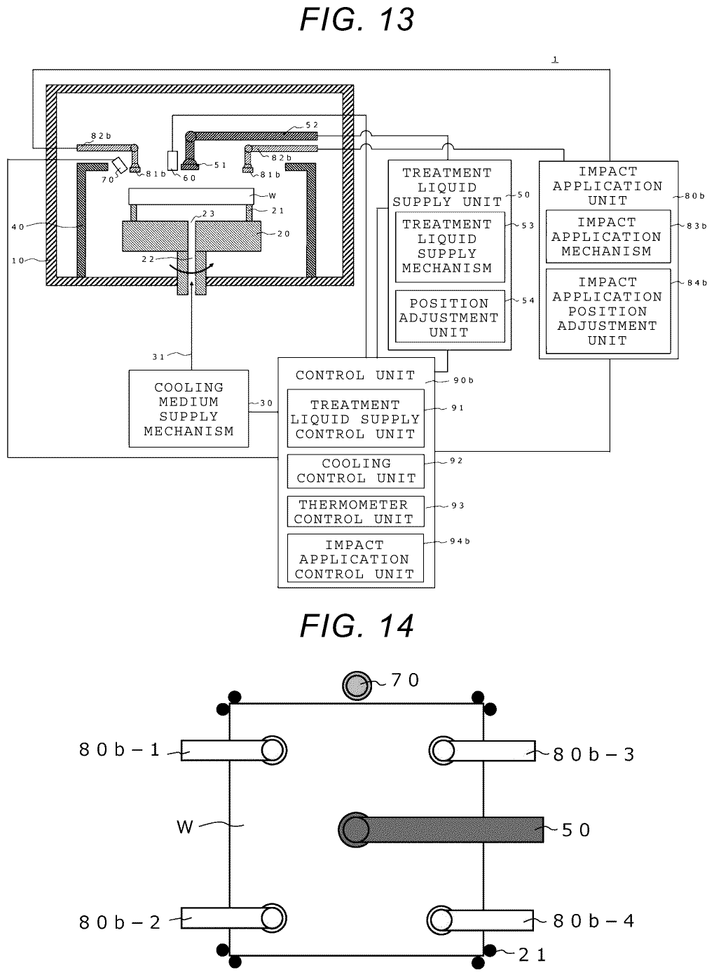

(Second Embodiment) FIG. 13 is a cross-sectional view schematically showing an example of a configuration of a substrate processing apparatus 1 according to a second embodiment. FIG. 14 is a top view schematically showing an example of the configuration of the substrate processing apparatus 1 according to the second embodiment. The substrate processing apparatus 1 includes the chamber 10, the stage 20, the cooling medium supply mechanism 30, the cleaning cup 40, the treatment liquid supply unit 50, the radiation thermometer 60, the thermometer 70, an impact application unit 80b, and a control unit 90b.

Since elements other than the impact application unit 80b and the control unit 90b may be similar to those in the first embodiment, description thereof will be omitted.

The impact application unit 80b includes a nozzle 81b, a nozzle head 82b, an impact application mechanism 83b, and an impact application position adjustment unit 84b. The impact application unit 80b is provided as a gas supply unit (gas supplier, gas source).

Based on the temperature measured by the thermometer 70, the impact application unit 80b moves horizontally or vertically to a location having high temperature in the treatment liquid layer 1000 formed on the substrate W, and ejects gas onto the location having high temperature in the treatment liquid layer 1000. The gas ejected from the impact application unit 80b is cooled and has a temperature equal to or lower than the freezing point of the treatment liquid layer 1000. Here, a plurality of impact application units 80b may be provided. By moving the impact application units 80b to a plurality of locations in the treatment liquid layer 1000, gas can be ejected simultaneously at a plurality of locations in the treatment liquid layer 1000.

One impact application unit 80b provided with a plurality of sets of the nozzle 81b and the nozzle head 82b may be provided, or a plurality of impact application units 80b each provided with one set of the nozzle 81b and the nozzle head 82b may be provided. When a plurality of impact application units 80b are provided, for example, four impact application units 80b are provided above the substrate W. Here, when the nozzle 81b and the nozzle head 82b are regarded as one set, four sets of the nozzle 81b and the nozzle head 82b are provided above the substrate W. The impact application mechanism 83b and the impact application position adjustment unit 84b may be provided for each impact application unit 80b, or one impact application mechanism 83b and one impact application position adjustment unit 84b may be shared by a plurality of impact application units 80b. The plurality of impact application units 80b may share one of the impact application mechanism 83b or the impact application position adjustment unit 84b, and the other may be provided for each of the plurality of impact application units 80b.

A case where four impact application units 80b are provided, such as 80b-1, 80b-2, 80b-3, and 80b-4, will be described below. The impact application units 80b-1, 80b-2, 80b-3, and 80b-4 may be collectively referred to as the impact application unit 80b.

After the treatment liquid layer 1000 is formed on the substrate W, the impact application unit 80b applies an impact to the treatment liquid layer 1000 when the treatment liquid layer 1000 has a temperature equal to or lower than the freezing point. The nozzle 81b and the nozzle head 82b of the impact application unit 80b are disposed above the treatment liquid layer 1000 and supply cooled gas. The temperature of the cooled gas is preferably lower than the freezing point of the treatment liquid supplied onto the substrate W from the treatment liquid supply unit 50. The gas supplied from the nozzle 81b is, for example, nitrogen.

The nozzle 81b and the nozzle head 82b are connected to the impact application mechanism 83b via a gas pipe (not shown). That is, the gas pipe (not shown) connects the nozzle head 82b to the impact application mechanism 83b.

The impact application mechanism 83b includes, for example, a gas storage unit that stores gas, a gas pipe, a pump, a valve, and a cooling unit, which are not shown. The gas storage unit stores the gas to be supplied onto the treatment liquid layer 1000. Here, the gas in the cooling gas storage unit may be cooled. In other words, the gas stored in the gas storage unit may be cooled by a method such as cooling the entire gas storage unit. For example, nitrogen is stored in the gas storage unit. The gas pipe connects the nozzle head 82b to the gas storage unit. The pump sends gas from the gas storage unit to the nozzle 81b via the gas pipe. The valve switches the supply of gas from the gas storage unit to the nozzle 81b on and off. The cooling unit cools the gas to a temperature lower than the freezing point of the treatment liquid supplied from the treatment liquid supply unit 50. The temperature of the gas supplied from the nozzle 81b only needs to be lower than the freezing point, and the cooling unit may be provided in any of the nozzle head 82b, the gas pipe, and the gas storage unit.

The gas storage unit in the impact application mechanism 83b may be provided separately for each of the impact application units 80b-1, 80b-2, 80b-3, and 80b-4, or may be shared by the impact application units 80b-1, 80b-2, 80b-3, and 80b-4.

The impact application position adjustment unit 84b can drive the nozzle 81b or the nozzle head 82b horizontally or vertically. The impact application units 80b-1, 80b-2, 80b-3, and 80b-4 can be driven independently by the impact application position adjustment unit 84b. Here, the impact application position adjustment units 84b may be provided independently and driven separately in the impact application units 80b-1, 80b-2, 80b-3, and 80b-4. In other words, the impact application position adjustment units 84b may be provided in each of the impact application units 80b-1, 80b-2, 80b-3, and 80b-4, and the impact application units 80b-1, 80b-2, 80b-3, and 80b-4 can be driven individually by the respective impact application position adjustment units 84b.

The control unit 90b controls the overall operation of the substrate processing apparatus 1 according to a recipe. The control unit 90b includes the treatment liquid supply control unit 91, the cooling control unit 92, the thermometer control unit 93, and an impact application control unit 94b.

The treatment liquid supply control unit 91, the cooling control unit 92, and the thermometer control unit 93 may be the same as those in the first embodiment, and thus description thereof will be omitted.

The impact application control unit 94b controls a blowing position and a blowing amount of gas from the impact application unit 80b. The impact application control unit 94b controls the impact application position adjustment unit 84b based on temperature information on the treatment liquid layer 1000 formed on the substrate W from the thermometer control unit 93, and disposes the nozzle 81b above the treatment liquid layer 1000. Here, the impact application unit 80b is driven by the impact application position adjustment unit 84b to a location having high temperature in the treatment liquid layer 1000. In other words, the thermometer control unit 93 transmits the temperature of the treatment liquid layer 1000 obtained by the thermometer 70 to the impact application control unit 94b. The impact application control unit 94b controls the impact application position adjustment unit 84b based on the received temperature information to dispose the nozzle 81b above a position having high temperature in the treatment liquid layer 1000. That is, the impact application control unit 94b instructs the impact application position adjustment unit 84b such that the nozzle 81b is disposed above a location having high temperature in the treatment liquid layer 1000.

Here, when a plurality of impact application units 80b are provided (for example, the aforementioned impact application units 80b-1, 80b-2, 80b-3, and 80b-4), the impact application control unit 94b gives instructions to the impact application position adjustment unit 84b to dispose the impact application units 80b-1, 80b-2, 80b-3, and 80b-4 at a plurality of locations having high temperature in the treatment liquid layer 1000, respectively. The impact application units 80b-1, 80b-2, 80b-3, and 80b-4, each disposed above the treatment liquid layer 1000, blow cooled gas onto the treatment liquid layer 1000 at a predetermined timing. Here, the impact application units 80b-1, 80b-2, 80b-3, and 80b-4 may simultaneously blow the cooled gas.

FIG. 14 is a top view schematically showing an example of the configuration of the treatment liquid supply unit 50 and the impact application unit 80b disposed above the substrate W in the substrate processing apparatus 1 of the second embodiment. When the treatment liquid is supplied from the treatment liquid supply unit 50 disposed above the center of the substrate W, the treatment liquid layer 1000 is formed over the entire substrate W. The treatment liquid layer 1000 is cooled by being supplied with the cooling medium 31. The temperature change of the treatment liquid layer is measured by the thermometer 70, and FIG. 14 is a schematic diagram showing a case where a temperature near four corners of the treatment liquid layer 1000 is high. Since the temperature of the treatment liquid layer 1000 near the four corners is high, the impact application units 80b-1, 80b-2, 80b-3, and 80b-4 are disposed near the four corners of the treatment liquid layer 1000, respectively.

Hereinafter, a case will be described in which the substrate W has a quadrilateral shape and the temperature of the treatment liquid layer 1000 formed near the four corners of the substrate W is high.

Next, a freeze cleaning method using the substrate processing apparatus 1 of the second embodiment will be described. In the second embodiment, freeze cleaning of the substrate W is performed similarly to the first embodiment. That is, the flow of freeze cleaning using the substrate processing apparatus 1 in the second embodiment is similar to that shown in FIG. 10.

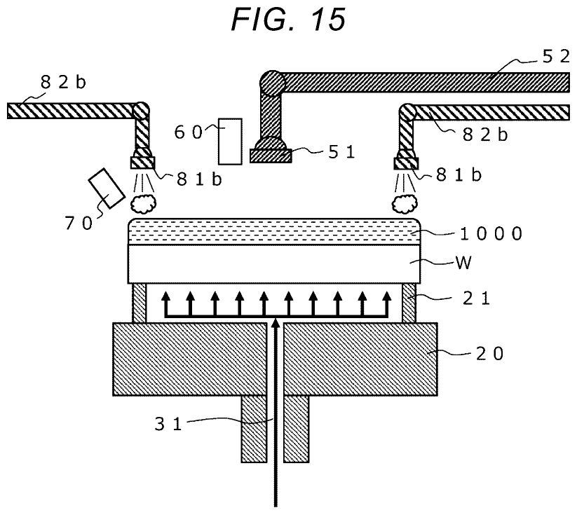

FIG. 15 is a view showing an example of procedures of a processing method of the substrate W in the second embodiment. FIG. 15 shows a stage in which the treatment liquid layer 1000 is formed on the substrate W and an impact is applied to the treatment liquid layer 1000 in a supercooled state. FIG. 15 shows a stage in the second embodiment corresponding to FIG. 5 of the first embodiment.

The method of processing the substrate W before and after FIG. 15 may be the same as in the first embodiment. That is, the same processes as those shown in FIGS. 3, 4, 6, and 7 are performed in the second embodiment, and thus description thereof will be omitted.

The substrate W carried into the substrate processing apparatus 1 of the second embodiment is placed on the stage 20. While the stage 20 rotates, the treatment liquid is supplied to the substrate W from the treatment liquid supply unit 50. Here, the cooling medium 31 is supplied toward the rear side of the substrate W, such that the treatment liquid layer 1000 reaches a supercooled state. Then, the radiation thermometer 60 measures the temperature at the center of the treatment liquid layer 1000, and when the temperature at the center of the treatment liquid layer 1000 becomes equal to or lower than the set temperature, the control unit 90b controls the impact application unit 80b to drive the nozzle 81b to be positioned above a location having high temperature in the treatment liquid layer 1000. The location having high temperature in the treatment liquid layer 1000 is detected by the thermometer 70 and the thermometer control unit 93.

As shown in FIG. 15, when the temperature of the center of the treatment liquid layer 1000 becomes equal to or lower than the set temperature, the impact application unit 80b applies an impact to the location having high temperature in the treatment liquid layer 1000.

Specifically, cooled gas is blown from the nozzle 81b toward the location having high temperature in the treatment liquid layer 1000. Here, the temperature of the gas blown from the nozzle 81b is lower than the freezing point of the treatment liquid. The temperature may be lower than the location having high temperature in the treatment liquid layer 1000.

Gas is blown from the nozzle 81b, and the impact of the blown gas coming into contact with the treatment liquid layer 1000 causes forced freezing to occur from a location in the treatment liquid layer 1000 with which the gas comes into contact.

The impact application control unit 94b controls the impact application position adjustment unit 84b to drive the nozzle 81b and the nozzle head 82b. The nozzle 81b and the nozzle head 82b are driven such that the position at which gas is blown from the nozzle 81b is disposed above a predetermined position in the treatment liquid layer 1000. That is, the impact application units 80b-1, 80b-2, 80b-3, and 80b-4 are driven by the impact application position adjustment unit 84b, and the respective nozzles 81b are disposed above a plurality of locations having high temperature in the treatment liquid layer 1000. Thus, the cooled gas is blown at approximately the same time onto the four locations having high temperature in the treatment liquid layer 1000.

The impact application control unit 94b controls the blowing amount of cooled gas from the impact application unit 80b. The cooled gas from the impact application unit 80b is blown with such an amount and force that the gas does not reach the surface of the treatment liquid layer 1000 that comes into contact with the substrate W, for example, when the gas is blown to the treatment liquid layer 1000.

The gas is blown from the nozzle 81b immediately before spontaneous freezing in the treatment liquid layer 1000 occurs. Therefore, when a part of the treatment liquid layer 1000 starts to solidify due to the impact of gas from the nozzle 81b coming into contact with the treatment liquid layer 1000, spontaneous freezing also occurs in the center of the treatment liquid layer 1000.

Also in the second embodiment, as shown in FIGS. 8 and 9, spontaneous freezing occurs in the center of the treatment liquid layer 1000, and forced freezing occurs at four end portions of the treatment liquid layer 1000 by blowing gas from the nozzle 81b.

By blowing gas from the impact application units 80b-1, 80b-2, 80b-3, and 80b-4, the starting points of freezing 1030A, 1030B, 1030C, and 1030D occur at four end portions of the treatment liquid layer 1000, and forced freezing starts. Since forced freezing occurs due to the impact from the impact application units 80b-1, 80b-2, 80b-3, and 80b-4 immediately before spontaneous freezing occurs, spontaneous freezing occurs after forced freezing occurs. Spontaneous freezing occurs from the starting point of freezing 1040 which is the center of the substrate W and the treatment liquid layer 1000 where the temperature is lowest. The treatment liquid layer 1000 gradually solidifies from the plurality of starting points of freezing. Thus, the solidified layer 1010 is formed.

After the treatment liquid layer 1000 solidifies, the treatment liquid is supplied onto the solidified layer 1010 similarly to the first embodiment, and the solidified layer 1010 thaws (e.g., so as to melt). Thus, the foreign substance that moved upward on the surface to be cleaned of the substrate W is washed away and removed by the treatment liquid.

As shown in FIGS. 8 and 9, also in the second embodiment, solidification is considered to progress radially from the starting points of freezing 1030 and 1040.

That is, according to the substrate processing apparatus 1 and the substrate processing method of the second embodiment, the same effects as those of the first embodiment can be achieved.

The gas blown from the nozzle 81b is cooled to a temperature equal to or lower than the freezing point of the treatment liquid that forms the treatment liquid layer 1000. Therefore, when an impact is applied to the treatment liquid layer 1000, the treatment liquid layer 1000 can be cooled from the upper surface of the treatment liquid layer 1000. Therefore, when cooled gas is blown onto the treatment liquid layer 1000, while an impact is applied to the treatment liquid layer 1000, the treatment liquid layer 1000 can be solidified by cooling the surface of the treatment liquid layer 1000 that comes into contact with the substrate W and the front surface of the treatment liquid layer 1000. In other words, since the treatment liquid layer 1000 is cooled from both the surface in contact with the substrate W and the front surface, the solidification time of the treatment liquid layer 1000 can be shortened.

The ejection speed of the gas blown from the nozzle 81b may be controlled by the impact application control unit 94b. Here, strength of the impact applied to the treatment liquid layer 1000 can be changed by changing the ejection speed of the cooled gas.

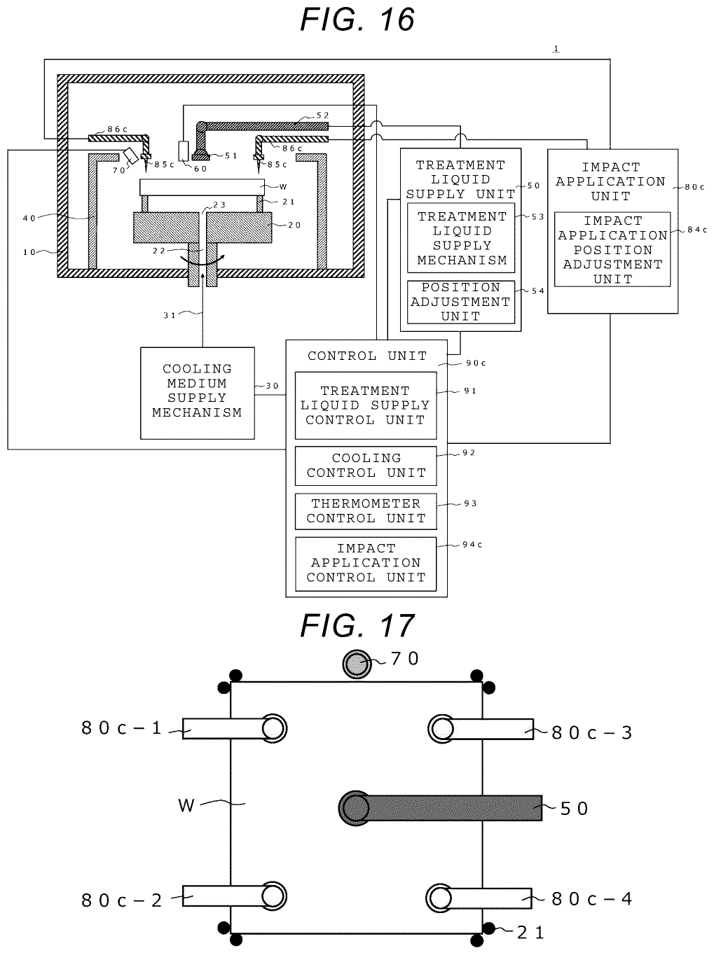

(Third Embodiment) FIG. 16 is a cross-sectional view schematically showing an example of a configuration of a substrate processing apparatus 1 according to a third embodiment. FIG. 17 is a top view schematically showing an example of the configuration of the substrate processing apparatus 1 according to the third embodiment. The substrate processing apparatus 1 includes the chamber 10, the stage 20, the cooling medium supply mechanism 30, the cleaning cup 40, the treatment liquid supply unit 50, the radiation thermometer 60, the thermometer 70, an impact application unit 80c, and a control unit 90c.

Since elements other than the impact application unit 80c and the control unit 90c may be similar to those in the first embodiment, description thereof will be omitted.

The impact application unit 80c includes an impact application position adjustment unit 84c, a contact portion 85c, and a support portion 86c.

The impact application unit 80c moves horizontally or vertically to a location having high temperature in the treatment liquid layer 1000 (described later) based on the temperature measured by the thermometer 70, and applies an impact to a predetermined location in the treatment liquid layer 1000. Specifically, the contact portion 85c directly contacts the treatment liquid layer 1000. Here, a plurality of impact application units 80c may be provided, such as impact application units 80c-1, 80c-2, 80c-3, and 80c-4. By moving the impact application units 80c above the treatment liquid layer, it is possible to apply impacts to a plurality of locations in the treatment liquid layer simultaneously.

One impact application unit 80c provided with a plurality of sets of the nozzle 81c and the nozzle head 82c may be provided, or a plurality of impact application units 80c each provided with one set of the nozzle 81c and the nozzle head 82c may be provided. When a plurality of impact application units 80c are provided, for example, four impact application units 80c are provided above the treatment liquid layer 1000. Here, when the contact portion 85c and the support portion 86c are regarded as one set, four sets of the contact portion 85c and the support portion 86c are provided above the substrate W. The impact application position adjustment unit 84c may be provided for each impact application unit 80c, or one impact application position adjustment unit 84c may be shared by a plurality of impact application units 80c.

A case where four impact application units 80c are provided, such as 80c-1, 80c-2, 80c-3, and 80c-4, will be described below. The impact application units 80c-1, 80c-2, 80c-3, and 80c-4 may be collectively referred to as the impact application unit 80c.

After the treatment liquid layer 1000 to be described later is formed on the substrate W, the impact application unit 80c applies an impact to the treatment liquid layer 1000 when the treatment liquid layer 1000 is the set temperature. The contact portion 85c and the support portion 86c of the impact application unit 80c are disposed above the treatment liquid layer 1000.

The impact application position adjustment unit 84c can drive the contact portion 85c and the support portion 86c horizontally or vertically. The impact application position adjustment unit 84c may be capable of rotating the contact portion 85c and the support portion 86c.

The impact application units 80c-1, 80c-2, 80c-3, and 80c-4 can be driven independently by the impact application position adjustment unit 84c. Here, the impact application position adjustment units 84c may be provided independently and driven separately in the impact application units 80c-1, 80c-2, 80c-3, and 80c-4. In other words, the impact application position adjustment units 84c may be provided in each of the impact application units 80c-1, 80c-2, 80c-3, and 80c-4, and the impact application units 80c-1, 80c-2, 80c-3, and 80c-4 can be driven individually by the respective impact application position adjustment units 84c.

After the treatment liquid layer 1000 is formed on the substrate W, the contact portion 85c comes into direct contact with a predetermined location of the treatment liquid layer 1000. The contact portion 85c may be, for example, shaped like a needle with a pointed tip end, or may be shaped like a rod having a constant width from one end portion connected to the support portion 86c to the other end portion (tip end). The contact portion 85c can change an area and a shape of contact with the treatment liquid layer 1000 as long as the temperature of the contacting position of the treatment liquid layer 1000 is not raised to be equal to or higher than the freezing point.

The support portion 86c supports the contact portion 85c. The support portion 86c is driven horizontally or vertically above the treatment liquid layer 1000 by the impact application position adjustment unit 84c.

The control unit 90c controls the overall operation of the substrate processing apparatus 1 according to a recipe. The control unit 90c includes the treatment liquid supply control unit 91, the cooling control unit 92, the thermometer control unit 93, and an impact application control unit 94c.

The treatment liquid supply control unit 91, the cooling control unit 92, and the thermometer control unit 93 may be the same as those in the first embodiment, and thus description thereof will be omitted.

The impact application control unit 94c controls the contact of the impact application unit 80c with the treatment liquid layer 1000. The impact application control unit 94c controls the impact application position adjustment unit 84c based on temperature information on the treatment liquid layer 1000 formed on the substrate W from the thermometer control unit 93, and disposes the contact portion 85c above the treatment liquid layer 1000. Here, the impact application unit 80c is driven by the impact application position adjustment unit 84c to a location having high temperature in the treatment liquid layer 1000. In other words, the thermometer control unit 93 transmits the temperature of the treatment liquid layer 1000 obtained by the thermometer 70 to the impact application control unit 94c. The impact application control unit 94c controls the impact application position adjustment unit 84c based on the received temperature information to dispose the contact portion 85c above a position having high temperature in the treatment liquid layer 1000. That is, the impact application control unit 94c instructs the impact application position adjustment unit 84c such that the contact portion 85c is disposed above a location having high temperature in the treatment liquid layer 1000.

Here, when a plurality of impact application units 80c are provided (for example, the aforementioned impact application units 80c-1, 80c-2, 80c-3, and 80c-4), the impact application control unit 94c gives instructions to the impact application position adjustment unit 84c to dispose the impact application units 80c-1, 80c-2, 80c-3, and 80c-4 at a plurality of locations having high temperature in the treatment liquid layer 1000, respectively. The impact application units 80c-1, 80c-2, 80c-3, and 80c-4 disposed above the treatment liquid layer 1000 bring the contact portions 85c into contact with the treatment liquid layer 1000 at a predetermined timing. Here, the impact application units 80c-1, 80c-2, 80c-3, and 80c-4 may contact the treatment liquid layer 1000 simultaneously.

FIG. 17 is a top view schematically showing an example of the configuration of the treatment liquid supply unit 50 and the impact application unit 80c disposed above the substrate W in the substrate processing apparatus 1 of the third embodiment. When the treatment liquid is supplied from the treatment liquid supply unit 50 disposed above the center of the substrate W, the treatment liquid layer 1000 is formed over the entire substrate W. When the contact portion 85c comes into contact with the treatment liquid layer 1000, an impact is applied to the treatment liquid layer 1000. The temperature change of the treatment liquid layer 1000 is measured by the thermometer 70, and FIG. 17 shows a schematic diagram in which a temperature near four corners of the substrate W is high. Since the temperature of the treatment liquid layer 1000 near the four corners is high, the impact application units 80c-1, 80c-2, 80c-3, and 80c-4 are disposed near the four corners of the treatment liquid layer 1000, respectively.

Hereinafter, a case will be described in which the substrate W has a quadrilateral shape and the temperature of the treatment liquid layer 1000 formed near the four corners of the substrate W is high.

A freeze cleaning method using the substrate processing apparatus 1 of the third embodiment will be described. In the third embodiment, freeze cleaning of the substrate W is performed similarly to the first embodiment. That is, the flow of freeze cleaning using the substrate processing apparatus 1 in the third embodiment is similar to that shown in FIG. 10.

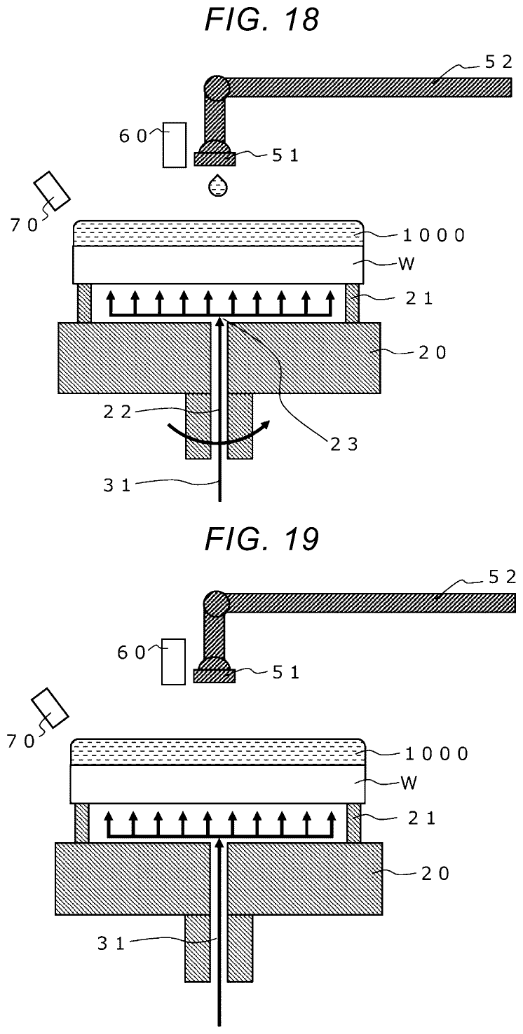

FIGS. 18 to 22 are views showing an example of procedures of a processing method of the substrate W in the third embodiment.

The procedures in FIGS. 18, 19, and 22 may be the same as those in FIGS. 3, 4, and 7 in the first embodiment, respectively, and will be described briefly.

First, the substrate W carried into the substrate processing apparatus 1 of the third embodiment is placed on the stage 20. Then, the treatment liquid is supplied onto the substrate W from the treatment liquid supply unit 50, as shown in FIG. 18. Here, the cooling medium 31 is supplied toward the surface of the substrate W opposite to the surface to be cleaned.

Next, as shown in FIG. 19, the treatment liquid layer 1000 is cooled by supplying the cooling medium 31, and the treatment liquid layer 1000 reaches a supercooled state. That is, the treatment liquid layer 1000 becomes liquid having a temperature equal to or lower than the freezing point. Here, the radiation thermometer 60 measures the temperature at the center of the treatment liquid layer 1000. When the temperature of the center of the treatment liquid layer 1000 is equal to or lower than the set temperature, the control unit 90c controls the impact application unit 80c to drive the contact portion 85c to be positioned above a location having high temperature in the treatment liquid layer 1000. The location having high temperature in the treatment liquid layer 1000 is detected by the thermometer 70 and the thermometer control unit 93.

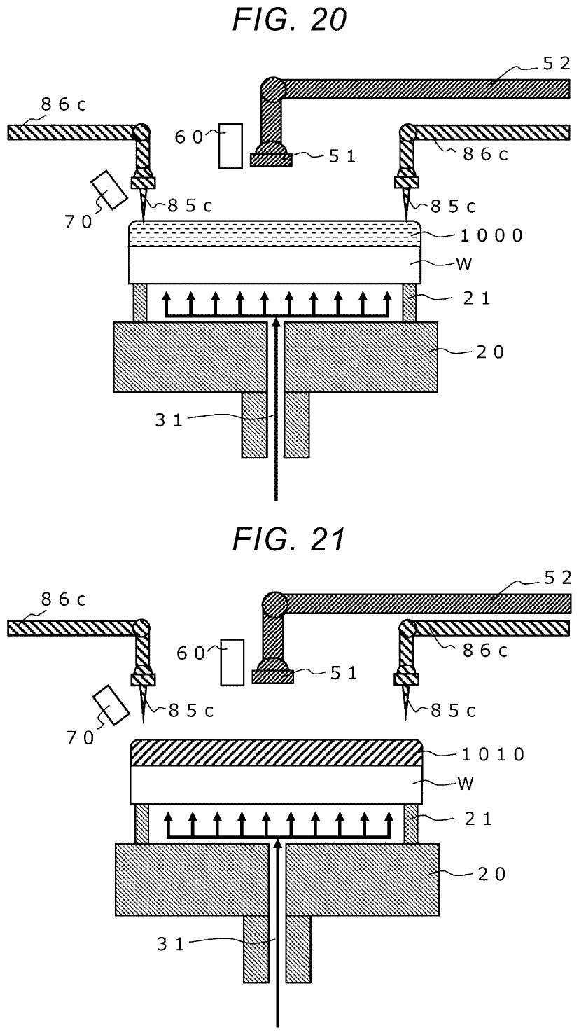

As shown in FIG. 20, when the temperature of the center of the treatment liquid layer 1000 is the set temperature, the impact application unit 80c applies an impact to the location having high temperature in the treatment liquid layer 1000. Specifically, the tip end of the contact portion 85c comes into contact with the treatment liquid layer 1000.

For example, when the substrate W is a template used in imprint lithography, it is preferable that the contact portion 85c comes into contact with an upper portion of a region of the substrate W other than a pattern region having a concave-convex pattern that contacts a resist on a workpiece. In other words, the contact portion 85c comes into contact with the treatment liquid layer 1000 formed above an outer periphery of the region in the template where a pattern to be transferred to the workpiece is disposed. Marks such as alignment marks for aligning with the workpiece are disposed in a region on the outer periphery of the region in which the pattern is disposed. That is, the contact portion 85c comes into contact with, for example, a region of the treatment liquid layer 1000 other than the pattern region of the substrate W, and a location having high temperature in the treatment liquid layer 1000. It is possible to apply an impact for solidifying the treatment liquid layer 1000 without damaging the pattern formed on the substrate W by the contact of the contact portion 85c.

The impact application control unit 94c controls the impact application position adjustment unit 84c to drive the contact portion 85c and the support portion 86c. The contact portion 85c is driven to be disposed above a location having high temperature in the treatment liquid layer 1000. That is, the impact application units 80c-1, 80c-2, 80c-3, and 80c-4 are driven by the impact application position adjustment unit 84c, and the respective contact portions 85c are disposed above a plurality of locations having high temperature in the treatment liquid layer 1000. Thus, the contact portions 85c come into contact with the four locations having high temperature in the treatment liquid layer 1000 at approximately the same time.

The contact portion 85c comes into contact with only the treatment liquid layer 1000. That is, the contact portion 85c comes into contact with the treatment liquid layer 1000 without directly contacting the substrate W. After the contact portion 85c comes into contact with the treatment liquid layer 1000, the contact portion 85c is separated from the treatment liquid layer 1000 before the treatment liquid layer 1000 solidifies.

As shown in FIG. 21, the impact of the contact portion 85c coming into contact with the treatment liquid layer 1000 causes forced freezing to occur from a location in the treatment liquid layer 1000 with which the contact portion 85c comes into contact.

The contact portion 85c comes into contact with the treatment liquid layer 1000 immediately before spontaneous freezing in the treatment liquid layer 1000 occurs. Therefore, when a part of the treatment liquid layer 1000 starts to solidify due to the impact of the contact portion 85c coming into contact with the treatment liquid layer 1000, spontaneous freezing also occurs in the center of the treatment liquid layer 1000. Thus, the solidified layer 1010 is formed.

Also in the third embodiment, as shown in FIGS. 8 and 9, spontaneous freezing occurs in the center of the treatment liquid layer 1000, and forced freezing occurs at four end portions of the treatment liquid layer 1000 due to contact with the contact portion 85c.

When the contact portions 85c of the impact application units 80c-1, 80c-2, 80c-3, and 80c-4 come into contact with the treatment liquid layer 1000, the starting points of freezing 1030A, 1030B, 1030C, and 1030D occur at four end portions of the treatment liquid layer 1000, and forced freezing starts. Since forced freezing occurs immediately before spontaneous freezing occurs, spontaneous freezing occurs after forced freezing occurs. Spontaneous freezing occurs from the starting point of freezing 1040 which is the center of the treatment liquid layer 1000 where the temperature is lowest. The treatment liquid layer 1000 solidifies from the plurality of starting points of freezing.

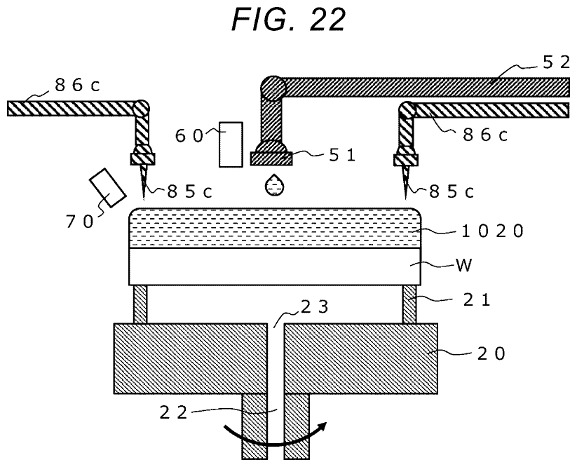

After the treatment liquid layer 1000 solidifies, as shown in FIG. 22, the treatment liquid is supplied onto the solidified layer 1010 similarly to the first embodiment, and the solidified layer 1010 thaws. Thus, the foreign substance that moved upward on the surface to be cleaned of the substrate W is washed away and removed by the treatment liquid.

As shown in FIGS. 8 and 9, also in the third embodiment, solidification is considered to progress radially from the starting points of freezing 1030 and 1040.

In other words, according to the substrate processing apparatus 1 and the substrate processing method of the third embodiment, the same effects as those of the first embodiment can be achieved.

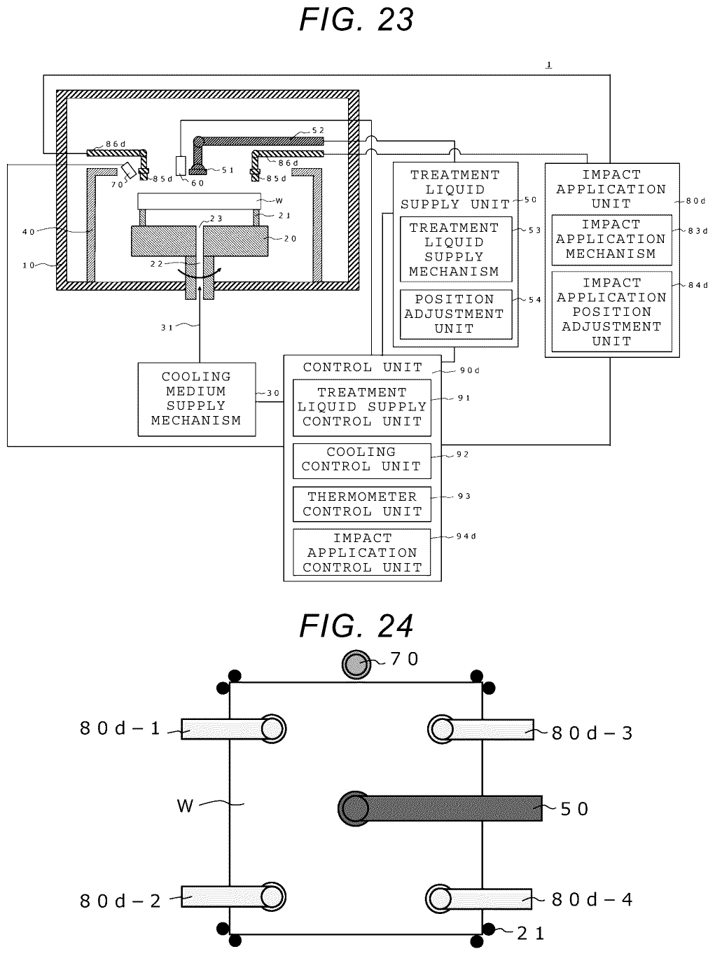

(Fourth Embodiment) FIG. 23 is a cross-sectional view schematically showing an example of a configuration of a substrate processing apparatus 1 according to a fourth embodiment. FIG. 24 is a top view schematically showing an example of the configuration of the substrate processing apparatus 1 according to the fourth embodiment. The substrate processing apparatus 1 includes the chamber 10, the stage 20, the cooling medium supply mechanism 30, the cleaning cup 40, the treatment liquid supply unit 50, the radiation thermometer 60, the thermometer 70, an impact application unit 80d, and a control unit 90d.

Since elements other than the impact application unit 80d and the control unit 90d may be similar to those in the first embodiment, description thereof will be omitted.

The impact application unit 80d includes an impact application mechanism 83d, an impact application position adjustment unit 84d, a contact portion 85d, and a support portion 86d.

Based on the temperature measured by the thermometer 70, the impact application unit 80d moves horizontally or vertically to a portion having high temperature in the treatment liquid layer 1000 formed on the substrate W, and drops the treatment liquid onto the portion having high temperature in the treatment liquid layer 1000. Here, a plurality of impact application units 80d may be provided, such as impact application units 80d-1, 80d-2, 80d-3, and 80d-4. By moving the impact application units 80d to a plurality of locations in the treatment liquid layer 1000, the treatment liquid can be dropped onto a plurality of locations in the treatment liquid layer 1000 simultaneously.

One impact application unit 80d provided with a plurality of sets of the nozzle 81d and the nozzle head 82d may be provided, or a plurality of impact application units 80d each provided with one set of the nozzle 81d and the nozzle head 82d may be provided. When a plurality of impact application units 80d are provided, for example, four impact application units 80d are provided above the substrate W. Here, when the contact portion 85d and the support portion 86d are regarded as one set, four sets of the contact portion 85d and the support portion 86d are provided above the substrate W. The impact application mechanism 83d and the impact application position adjustment unit 84d may be provided for each impact application unit 80d, or one impact application mechanism 83d and one impact application position adjustment unit 84d may be shared by a plurality of impact application units 80d. The plurality of impact application units 80d may share one of the impact application mechanism 83d or the impact application position adjustment unit 84d, and the other may be provided for each of the plurality of impact application units 80d.

A case where four impact application units 80d are provided, such as 80d-1, 80d-2, 80d-3, and 80d-4, will be described below. The impact application units 80d-1, 80d-2, 80d-3, and 80d-4 may be collectively referred to as the impact application unit 80d.

After the treatment liquid layer 1000 to be described later is formed on the substrate W, the impact application unit 80d applies an impact to the treatment liquid layer 1000 when the treatment liquid layer 1000 has a temperature equal to or lower than the freezing point. The contact portion 85d and the support portion 86d of the impact application unit 80d are disposed above the substrate W.

As the impact application mechanism 83d, for example, a power supply (not shown) is provided. When the power supply is turned on, a voltage is output to the contact portion 85d, and ultrasonic waves are generated from the contact portion 85d.

The impact application position adjustment unit 84d is similar to the impact application position adjustment unit 84c in the third embodiment, and therefore description thereof will be omitted.

After the treatment liquid layer 1000 is formed on the substrate W, the contact portion 85d comes into direct contact with a predetermined location of the treatment liquid layer 1000. The contact portion 85d vibrates by ultrasonic waves, and can vibrate the treatment liquid layer 1000 when the contact portion 85d comes into contact with the treatment liquid layer 1000, which will be described later.

The contact portion 85d may have, for example, a rectangular surface which comes into contact with the treatment liquid layer 1000, and may be cubic or rectangular. The contact portion 85d may be, for example, shaped like a needle with a pointed tip end, or may be shaped like a rod having a constant width from one end portion connected to the support portion 86d to the other end portion (tip end). The contact portion 85d can change an area and a shape of contact with the treatment liquid layer 1000 as long as the temperature of the contacting position of the treatment liquid layer 1000 is not raised to be equal to or higher than the freezing point.

The support portion 86d supports the contact portion 85d. The support portion 86d is driven horizontally or vertically above the treatment liquid layer 1000 by the impact application position adjustment unit 84d. The support portion 86d may be provided to be rotatable.

The control unit 90d controls the overall operation of the substrate processing apparatus 1 according to a recipe. The control unit 90d includes the treatment liquid supply control unit 91, the cooling control unit 92, the thermometer control unit 93, and an impact application control unit 94d.

The treatment liquid supply control unit 91, the cooling control unit 92, and the thermometer control unit 93 may be the same as those in the first embodiment, and thus description thereof will be omitted.

The impact application control unit 94d controls contact of the impact application unit 80d with the treatment liquid layer 1000, and frequency and the like of the ultrasonic waves generated by the impact application unit 80d. The impact application control unit 94d controls the impact application position adjustment unit 84d based on the temperature information on the treatment liquid layer 1000 from the thermometer control unit 93, and disposes the contact portion 85d above the treatment liquid layer 1000. Here, the impact application unit 80d is driven by the impact application position adjustment unit 84d to a location having high temperature in the treatment liquid layer 1000. In other words, the thermometer control unit 93 transmits the temperature of the treatment liquid layer 1000 obtained by the thermometer 70 to the impact application control unit 94d. The impact application control unit 94d controls the impact application position adjustment unit 84d based on the received temperature information to dispose the contact portion 85d above a predetermined location in the treatment liquid layer 1000. That is, the impact application control unit 94d instructs the impact application position adjustment unit 84d such that the contact portion 85d is disposed above a location having high temperature in the treatment liquid layer 1000 of the substrate W.

The impact application control unit 94d adjusts the frequency and the like of the ultrasonic waves emitted from the impact application unit 80d. In other words, the impact application control unit 94d adjusts the frequency and the like of the ultrasonic waves generated from the contact portion 85d. By controlling the frequency of the ultrasonic waves from the impact application control unit 94d, strength of the vibration of the contact portion 85d caused by the ultrasonic waves can be adjusted.

Here, when a plurality of impact application units 80d are provided, the impact application control unit 94d instructs the impact application position adjustment unit 84d to dispose the impact application units 80d-1, 80d-2, 80d-3, and 80d-4 at a plurality of locations having high temperature in the treatment liquid layer 1000, respectively. The impact application units 80d-1, 80d-2, 80d-3, and 80d-4 disposed above the treatment liquid layer 1000 bring the contact portions 85d into contact with the treatment liquid layer 1000 at a predetermined timing. Here, the impact application units 80d-1, 80d-2, 80d-3, and 80d-4 may contact the treatment liquid layer 1000 simultaneously.

The top view schematically showing an example of the configuration of the treatment liquid supply unit 50 and the impact application unit 80d disposed above the substrate W in the substrate processing apparatus 1 of the fourth embodiment may be similar to FIG. 17 in the third embodiment, and thus description thereof will be omitted.

Hereinafter, a case will be described in which the substrate W has a quadrilateral shape and the temperature of the treatment liquid layer 1000 formed near four corners of the substrate W is high. A freeze cleaning method using the substrate processing apparatus 1 of the fourth embodiment will be described. In the fourth embodiment, freeze cleaning of the substrate W is performed similarly to the first embodiment. That is, the flow of freeze cleaning using the substrate processing apparatus 1 in the fourth embodiment is similar to that shown in FIG. 10.

FIGS. 25 to 29 are views showing an example of procedures of a processing method of the substrate W in the fourth embodiment.

The procedures in FIGS. 25, 26 and 29 may be the same as those in FIGS. 4, 5, and 7 in the first embodiment, respectively, and will be described briefly.

First, the substrate W carried into the substrate processing apparatus 1 of the fourth embodiment is placed on the stage 20. Then, the treatment liquid is supplied onto the substrate W from the treatment liquid supply unit 50, as shown in FIG. 25. Here, the cooling medium 31 is supplied toward the surface of the substrate W opposite to the surface to be cleaned.

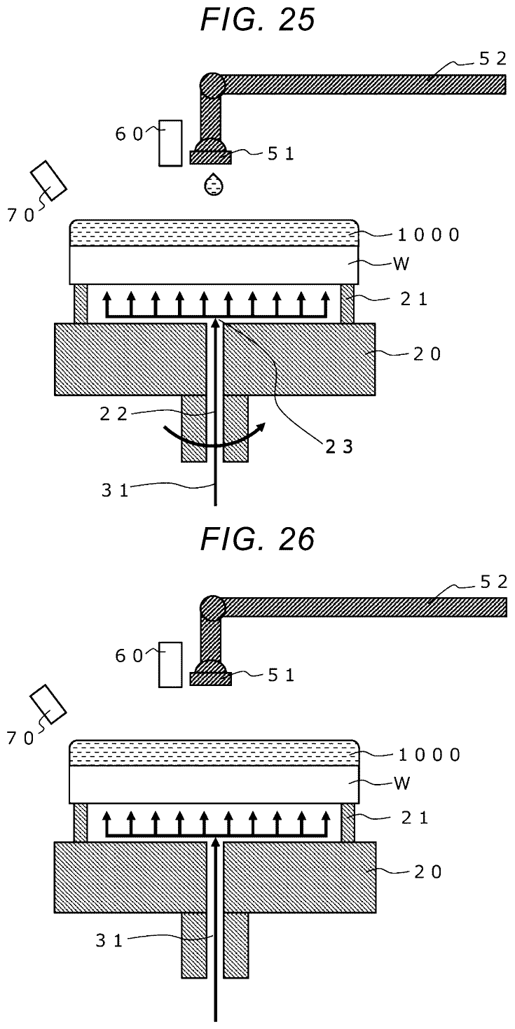

Next, as shown in FIG. 26, the treatment liquid layer 1000 is cooled by supplying the cooling medium 31, and the treatment liquid layer 1000 reaches a supercooled state.

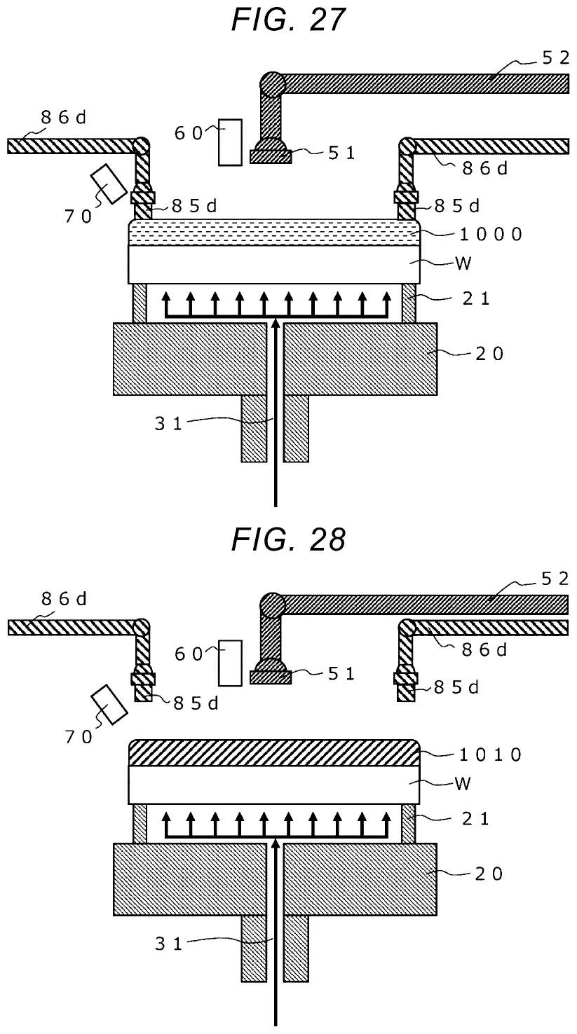

As shown in FIG. 27, when the temperature of the center of the treatment liquid layer 1000 is the set temperature, the impact application unit 80d applies an impact to the location having high temperature in the treatment liquid layer 1000. Specifically, the tip end of the contact portion 85d comes into contact with the treatment liquid layer 1000.

It is preferable that the contact portion 85d comes into contact with the treatment liquid layer 1000 in a predetermined region of the treatment liquid layer 1000. The predetermined region is as described above in the third embodiment. That is, the contact portion 85d comes into contact with, for example, a region of the treatment liquid layer 1000 other than the pattern region of the substrate W and a location having high temperature in the treatment liquid layer 1000. That is, also in the fourth embodiment, similar to the third embodiment, it is possible to apply an impact for solidification to the treatment liquid layer 1000 without damaging the pattern on the substrate W.

The impact application control unit 94d controls the impact application position adjustment unit 84d to drive the contact portion 85d and the support portion 86d. The contact portion 85d is driven to be disposed above a location having high temperature in the treatment liquid layer 1000. That is, the impact application units 80d-1, 80d-2, 80d-3, and 80d-4 are driven by the impact application position adjustment unit 84d, and the respective contact portions 85d are disposed above a plurality of locations having high temperature in the treatment liquid layer 1000. Thus, the contact portions 85d come into contact with the four locations having high temperature in the treatment liquid layer 1000 at approximately the same time.

The contact portion 85d generates ultrasonic waves and vibrates. The range of the ultrasonic waves generated from the contact portion 85d is, for example, equal to or higher than 20 khz.

The contact portion 85d comes into contact with only the treatment liquid layer 1000. That is, the contact portion 85d comes into contact with the treatment liquid layer 1000 without directly contacting the substrate W. After the contact portion 85d comes into contact with the treatment liquid layer 1000, the contact portion 85d is separated from the treatment liquid layer 1000 before the treatment liquid layer 1000 solidifies.

As shown in FIG. 28, when the contact portion 85d comes into contact with the treatment liquid layer 1000, an impact is applied to the treatment liquid layer 1000 by ultrasonic waves generated from the contact portion 85d. The impact from the contact portion 85d causes forced freezing to occur from a location in the treatment liquid layer 1000 with which the contact portion 85d comes into contact.

The contact portion 85d comes into contact with the treatment liquid layer 1000 immediately before spontaneous freezing in the treatment liquid layer 1000 occurs. Therefore, when the impact due to the ultrasonic waves generated from the contact portion 85d is transmitted to the treatment liquid layer 1000 and a part of the treatment liquid layer 1000 starts to solidify, spontaneous freezing also occurs in the center of the treatment liquid layer 1000. Thus, the solidified layer 1010 is formed.

Also in the fourth embodiment, as shown in FIGS. 8 and 9, spontaneous freezing occurs in the center of the treatment liquid layer 1000, and forced freezing occurs at four end portions of the treatment liquid layer 1000 due to contact with the contact portions 85d.

When the contact portions 85d of the impact application units 80d-1, 80d-2, 80d-3, and 80d-4 come into contact with the treatment liquid layer 1000, the starting points of freezing 1030A, 1030B, 1030C, and 1030D occur at four end portions of the treatment liquid layer 1000, and forced freezing starts. Since forced freezing occurs immediately before spontaneous freezing occurs, spontaneous freezing occurs after forced freezing occurs. Spontaneous freezing occurs from the starting point of freezing 1040 which is the center of the treatment liquid layer 1000 where the temperature is lowest. The treatment liquid layer 1000 solidifies from the plurality of starting points of freezing.

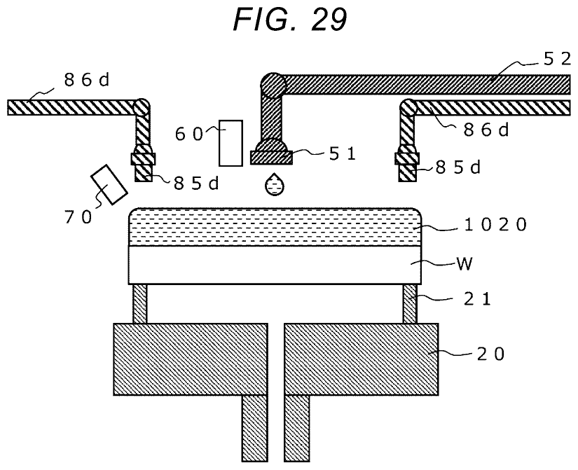

After the treatment liquid layer 1000 solidifies, as shown in FIG. 29, the treatment liquid is supplied onto the solidified layer 1010 similarly to the first embodiment, and the solidified layer 1010 thaws. Thus, the foreign substance that moved upward on the surface to be cleaned of the substrate W is washed away and removed by the treatment liquid.

As shown in FIGS. 8 and 9, also in the fourth embodiment, solidification is considered to progress radially from the starting points of freezing 1030 and 1040.

That is, according to the substrate processing apparatus 1 and the substrate processing method of the fourth embodiment, the same effects as those of the first embodiment can be achieved.

Output of the ultrasonic waves generated from the contact portion 85d may be controlled by the impact application control unit 94d. Here, by changing the output of the ultrasonic waves, it is possible to control the vibration caused by the generation of the ultrasonic waves at the contact portion 85d, and strength of the impact applied to the treatment liquid layer 1000 can be changed.

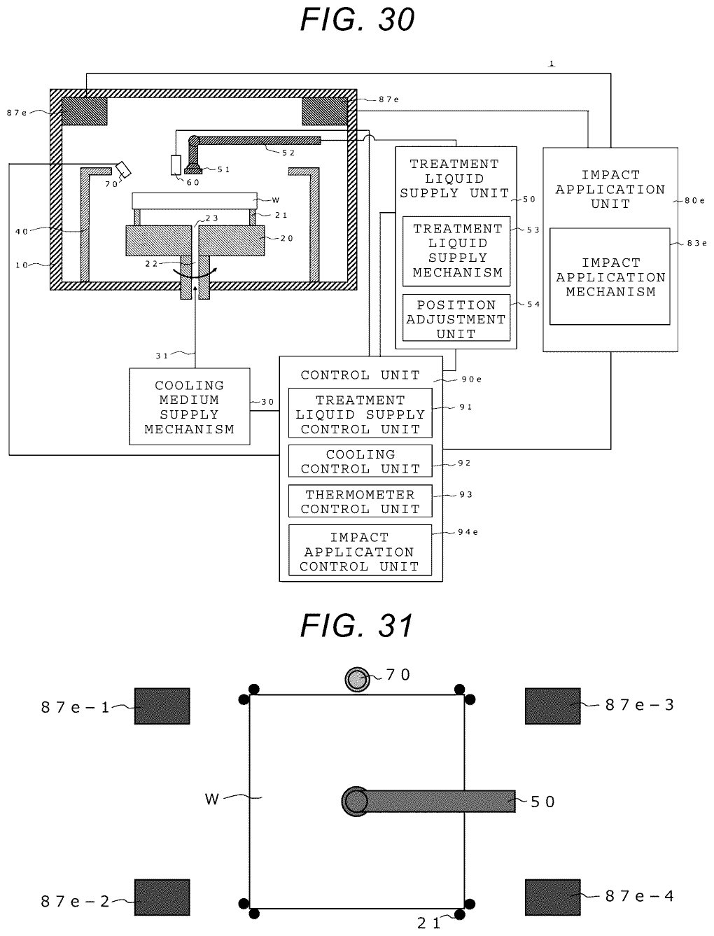

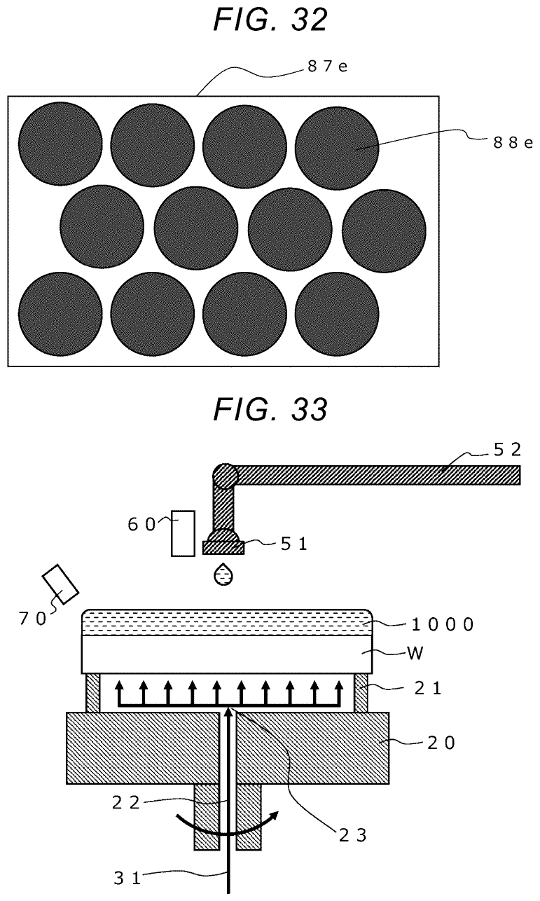

(Fifth Embodiment) FIG. 30 is a cross-sectional view schematically showing an example of a configuration of a substrate processing apparatus 1 according to a fifth embodiment. FIG. 31 is a top view schematically showing an example of the configuration of the substrate processing apparatus 1 according to the fifth embodiment. FIG. 32 is a diagram of an ultrasonic oscillator 87e in the substrate processing apparatus 1 according to the fifth embodiment. FIG. 32 is a bottom view of the ultrasonic oscillator 87e, and in other words, FIG. 32 is a view of the ultrasonic oscillator 87e as seen from the stage 20 side.

The substrate processing apparatus 1 includes the chamber 10, the stage 20, the cooling medium supply mechanism 30, the cleaning cup 40, the treatment liquid supply unit 50, the radiation thermometer 60, the thermometer 70, an impact application unit 80e, and a control unit 90e.

Since elements other than the impact application unit 80e and the control unit 90e may be similar to those in the first embodiment, description thereof will be omitted.

The impact application unit 80e includes an impact application mechanism 83e and the ultrasonic oscillator 87e.

After the treatment liquid layer 1000 to be described later is formed on the substrate W, the impact application unit 80e applies an impact to the treatment liquid layer 1000 when the treatment liquid layer 1000 has a temperature equal to or lower than the freezing point.

As the impact application mechanism 83e, for example, a power supply (not shown) is provided. When the power supply is turned on, ultrasonic waves are generated from the ultrasonic oscillator 87e.

The ultrasonic oscillator 87e is provided above the stage 20 in the chamber 10. The ultrasonic oscillator 87e generates ultrasonic waves to a location having high temperature in the substrate W based on the temperature measured by the thermometer 70. Here, a plurality of ultrasonic oscillators 87e may be provided, such as ultrasonic oscillators 87e-1, 87e-2, 87e-3, and 87e-4. By providing the ultrasonic oscillators 87e at a plurality of locations on the surface to be cleaned of the substrate W, ultrasonic waves can be applied to a plurality of locations on the substrate W simultaneously.

When a plurality of ultrasonic oscillators 87e are provided, for example, four ultrasonic oscillators 87e are provided above the substrate W. Here, a power supply may be provided for each ultrasonic oscillator 87e, or a plurality of ultrasonic oscillators 87e may share a power supply.

Hereinafter, a case where four ultrasonic oscillators 87e are provided, such as 87e-1, 87e-2, 87e-3, and 87e-4, will be described. The ultrasonic oscillators 87e-1, 87e-2, 87e-3, and 87e-4 may be collectively referred to as the ultrasonic oscillator 87e.

After the treatment liquid layer is formed on the substrate W, the ultrasonic oscillator 87e generates ultrasonic waves toward a predetermined location in the treatment liquid layer 1000. The ultrasonic oscillator 87e is provided with a plurality of ultrasonic oscillator elements 88e.

A plurality of ultrasonic oscillator elements 88e are arranged in an array in the ultrasonic oscillator 87e, and ultrasonic waves are generated from each of the ultrasonic oscillator elements 88e. The ultrasonic waves generated from the ultrasonic oscillator elements 88e interfere with each other, such that the ultrasonic waves generated from the ultrasonic oscillators 87e are focused. Therefore, ultrasonic waves generated from one ultrasonic oscillator 87e into the chamber 10 can be generated at one location in the treatment liquid layer 1000.

The control unit 90e controls the overall operation of the substrate processing apparatus 1 according to a recipe. The control unit 90e includes the treatment liquid supply control unit 91, the cooling control unit 92, the thermometer control unit 93, and an impact application control unit 94e.

The treatment liquid supply control unit 91, the cooling control unit 92, and the thermometer control unit 93 may be the same as those in the first embodiment, and thus description thereof will be omitted.

The impact application control unit 94e controls the frequency and the like of the ultrasonic waves generated from the impact application unit 80e to the treatment liquid layer 1000. The impact application control unit 94e controls the impact application position adjustment unit 84e based on the temperature information on the treatment liquid layer 1000 transmitted from the thermometer control unit 93, and adjusts a direction of the ultrasonic waves generated from the ultrasonic oscillator 87e. Here, the ultrasonic waves generated from the ultrasonic oscillator 87e are controlled by the impact application control unit 94e such that the ultrasonic waves are applied to a location having high temperature in the treatment liquid layer 1000 formed on the substrate W. In other words, the thermometer control unit 93 transmits the temperature of the treatment liquid layer 1000 obtained by the thermometer 70 to the impact application control unit 94e. Based on the received temperature information, the impact application control unit 94e controls the frequency of the ultrasonic oscillator 87e such that ultrasonic waves are generated from the ultrasonic oscillator 87e toward a position having high temperature in the treatment liquid layer 1000.

Here, when a plurality of impact application units 80e are provided, the impact application control unit 94e controls the respective ultrasonic oscillators 87e-1, 87e-2, 87e-3, and 87e-4. Therefore, frequencies of the ultrasonic oscillators 87e-1, 87e-2, 87e-3, and 87e-4 are adjusted by the impact application control unit 94e such that ultrasonic waves can be applied to a plurality of locations having high temperature in the treatment liquid layer 1000, respectively.

Hereinafter, a case will be described in which the substrate W has a quadrilateral shape and the temperature of the treatment liquid layer 1000 formed near four corners of the substrate W is high.

A freeze cleaning method using the substrate processing apparatus 1 of the fifth embodiment will be described. In the fifth embodiment, freeze cleaning of the substrate W is performed similarly to the first embodiment. That is, the flow of freeze cleaning using the substrate processing apparatus 1 in the fifth embodiment is similar to that shown in FIG. 10.

FIGS. 33 to 37 are views showing an example of procedures of a processing method of the substrate W in the fifth embodiment.

The procedures in FIGS. 33, 34 and 37 may be the same as those in FIGS. 3, 4, and 7 in the first embodiment, respectively, and will be described briefly.

First, the substrate W carried into the substrate processing apparatus 1 of the fifth embodiment is placed on the stage 20. Then, the treatment liquid is supplied onto the substrate W from the treatment liquid supply unit 50, as shown in FIG. 33. Here, the cooling medium 31 is supplied toward the surface of the substrate W opposite to the surface to be cleaned.

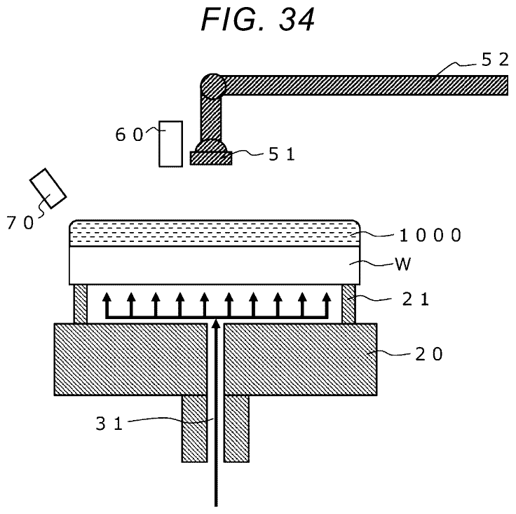

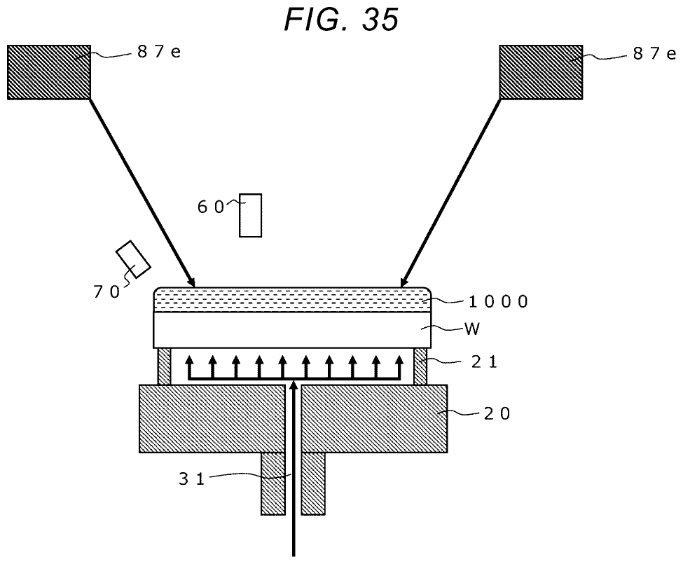

Next, as shown in FIG. 34, the treatment liquid layer 1000 is cooled by supplying the cooling medium 31, and the treatment liquid layer 1000 reaches a supercooled state.

As shown in FIG. 35, when the temperature of the center of the treatment liquid layer 1000 is equal to or lower than the set temperature, the impact application unit 80e applies an impact to the location having high temperature in the treatment liquid layer 1000. Specifically, the temperature of the center of the treatment liquid layer 1000 is measured by the radiation thermometer 60, and when the temperature of the center is equal to or lower than the set temperature, the impact application control unit 94e controls the ultrasonic oscillator 87e to generate ultrasonic waves.

The impact application control unit 94e controls the ultrasonic oscillator 87e, and adjusts the frequency such that ultrasonic waves are generated toward a location having high temperature in the treatment liquid layer 1000. That is, the ultrasonic oscillators 87e-1, 87e-2, 87e-3, and 87e-4 are controlled by the impact application control unit 94e, and each of the ultrasonic oscillators 87e generates ultrasonic waves toward a plurality of locations having high temperature in the treatment liquid layer 1000. Thus, ultrasonic waves are applied to the four locations having high temperature in the treatment liquid layer 1000 at approximately the same time. The ultrasonic waves are applied to a portion near the front surface of the treatment liquid layer 1000 (the surface opposite to the surface in contact with the substrate W). That is, the ultrasonic waves do not hit the substrate W but hit the treatment liquid layer 1000.

The range of the ultrasonic waves generated by the ultrasonic oscillator 87e is, for example, equal to or higher than 20 khz.

After the ultrasonic oscillator 87e generates ultrasonic waves toward the treatment liquid layer 1000 for a certain period of time, the ultrasonic oscillator 87e stops generating the ultrasonic waves.

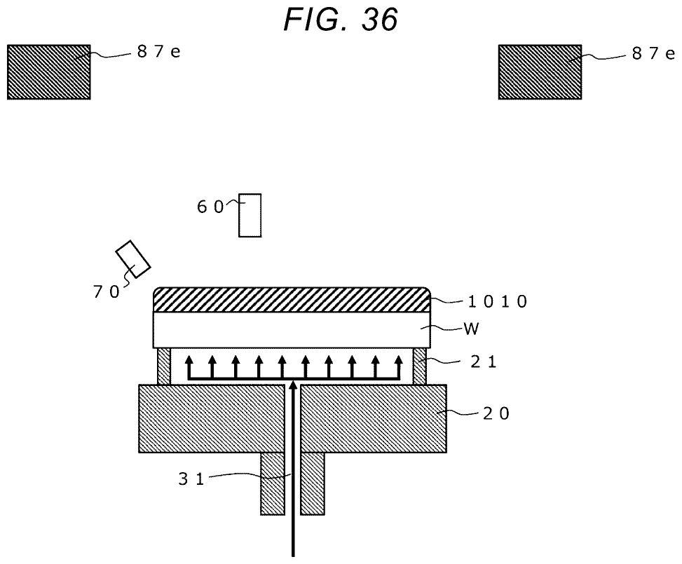

As shown in FIG. 36, an impact is applied to the treatment liquid layer 1000 by ultrasonic waves generated from the ultrasonic oscillator 87e. The impact causes forced freezing to occur from a location in the treatment liquid layer 1000 where the ultrasonic waves hit.

The ultrasonic oscillator 87e starts generating ultrasonic waves immediately before spontaneous freezing in the treatment liquid layer 1000 occurs. Therefore, when the impact due to the ultrasonic waves generated from the ultrasonic oscillator 87e is transmitted to the treatment liquid layer 1000 and a part of the treatment liquid layer 1000 starts to solidify, spontaneous freezing also occurs in the center of the treatment liquid layer 1000. Thus, the solidified layer 1010 is formed.

Also in the fifth embodiment, as shown in FIGS. 8 and 9, spontaneous freezing occurs in the center of the treatment liquid layer 1000, and forced freezing occurs at four end portions of the treatment liquid layer 1000 due to ultrasonic waves hitting the treatment liquid layer 1000.

By the generation of ultrasonic waves from the ultrasonic oscillators 87e-1, 87e-2, 87e-3, and 87e-4, the starting points of freezing 1030A, 1030B, 1030C, and 1030D occur at four end portions of the treatment liquid layer 1000, and forced freezing starts. Since forced freezing occurs immediately before spontaneous freezing occurs, spontaneous freezing occurs after forced freezing occurs. Spontaneous freezing occurs from the starting point of freezing 1040 which is the center of the treatment liquid layer 1000 where the temperature is lowest. The treatment liquid layer 1000 solidifies from the plurality of starting points of freezing.

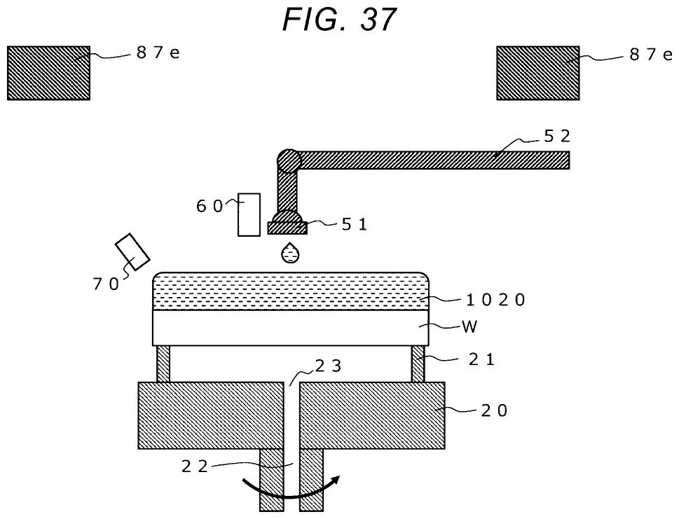

After the treatment liquid layer 1000 solidifies, as shown in FIG. 37, the treatment liquid is supplied onto the solidified layer 1010 similarly to the first embodiment, and the solidified layer 1010 thaws. Thus, the foreign substance that moved upward on the surface to be cleaned of the substrate W is washed away and removed by the treatment liquid.

As shown in FIGS. 8 and 9, also in the fifth embodiment, solidification is considered to progress radially from the starting points of freezing 1030 and 1040.

That is, according to the substrate processing apparatus 1 and the substrate processing method of the fifth embodiment, the same effects as those of the first embodiment can be achieved.

According to the configuration of the fifth embodiment, a foreign substance adhered to the impact application unit 80e and liquid generated by condensation or the like can be prevented from dropping onto or adhering to the substrate W and the treatment liquid layer 1000.

The ultrasonic waves generated from the ultrasonic oscillator 87e may be controlled by the impact application control unit 94e. Here, by changing the frequency of the ultrasonic waves generated from the ultrasonic oscillator element 88e, interference of ultrasonic waves between a plurality of ultrasonic oscillator elements 88e in one ultrasonic oscillator 87e can be controlled, and strength of the impact applied to the treatment liquid layer 1000 can be changed.

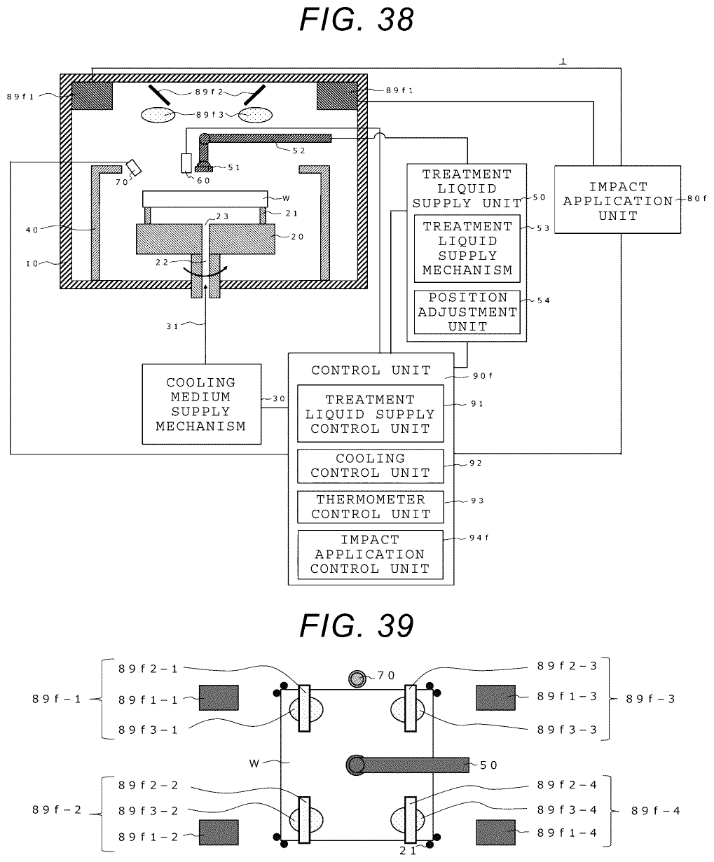

(Sixth Embodiment) FIG. 38 is a cross-sectional view schematically showing an example of a configuration of a substrate processing apparatus 1 according to a sixth embodiment. FIG. 39 is a top view schematically showing an example of the configuration of the substrate processing apparatus 1 according to the sixth embodiment. The substrate processing apparatus 1 includes the chamber 10, the stage 20, the cooling medium supply mechanism 30, the cleaning cup 40, the treatment liquid supply unit 50, the radiation thermometer 60, the thermometer 70, an impact application unit 80f, and a control unit 90f.

Since elements other than the impact application unit 80f and the control unit 90f may be similar to those in the first embodiment, description thereof will be omitted.

The impact application unit 80f includes a laser unit (a laser, a laser source) 89f.

The laser unit 89f includes a light source unit 89f1, a mirror 89f2, and a lens 89f3.

The laser unit 89f is provided above the stage 20 in the chamber 10. The laser unit 89f irradiates a location having high temperature in the substrate W with a laser based on the temperature measured by the thermometer 70. Here, a plurality of laser units 89f may be provided, such as laser units 89f-1, 89f-2, 89f-3, and 89f-4. Here, a plurality of light source units 89f1, mirrors 89f2, and lenses 89f3 are also provided. By providing the laser units 89f at a plurality of locations above the surface to be cleaned of the substrate W, a plurality of locations in the treatment liquid layer 1000 formed on the substrate W can be irradiated with a laser simultaneously.

When a plurality of laser units 89f are provided and the light source unit 89f1, the mirror 89f2, and the lens 89f3 are regarded as one set, for example, four sets of the light source unit 89f1, the mirror 89f2, and the lens 89f3 are provided above the stage 20.

Hereinafter, a case will be described in which four laser units 89f are provided, such as laser units 89f-1, 89f-2, 89f-3, and 89f-4. The laser units 89f-1, 89f-2, 89f-3, and 89f-4 may be collectively referred to as the laser unit 89f.

After the treatment liquid layer 1000 to be described later is formed on the substrate W, the impact application unit 80f applies an impact to the treatment liquid layer 1000 when the treatment liquid layer 1000 has the set temperature.

The laser unit 89f includes the light source unit 89f1, the mirror 89f2, and the lens 89f3, and irradiates the treatment liquid layer 1000 with a laser when the temperature of the center of the treatment liquid layer 1000 is equal to or lower than the set temperature.

Under the control of the impact application control unit 94f to be described later, the light source unit 89f1 irradiates inside of the chamber 10 with a laser when the temperature of the treatment liquid layer 1000 is equal to or lower than the set temperature.

The mirror 89f2 reflects the laser such that the lens 89f3, which will be described later, is irradiated with the laser emitted from the light source unit 89f1. By adjusting the inclination of the mirror 89f2, an irradiation position of the laser in the treatment liquid layer 1000 can be adjusted.

The lens 89f3 focuses the laser emitted from the light source unit 89f1 and reflected by the mirror 89f2. Thus, a predetermined location in the treatment liquid layer 1000 can be irradiated with a laser. The predetermined location is, for example, a location having high temperature in the treatment liquid layer 1000.

The inclination of the mirror 89f2 and the lens 89f3 may be adjusted by a driving mechanism (not shown). Here, the driving mechanism is controlled by the impact application control unit 94f.

The control unit 90f controls the overall operation of the substrate processing apparatus 1 according to a recipe. The control unit 90f includes the treatment liquid supply control unit 91, the cooling control unit 92, the thermometer control unit 93, and an impact application control unit 94f.

The treatment liquid supply control unit 91, the cooling control unit 92, and the thermometer control unit 93 may be the same as those in the first embodiment, and thus description thereof will be omitted.

The impact application control unit 94f controls an intensity of the laser to be emitted to the treatment liquid layer 1000 from the impact application unit 80f. The impact application control unit 94f may control the mirror 89f2 and the lens 89f3 based on temperature information on the treatment liquid layer 1000 transmitted from the thermometer control unit 93, and adjust a direction of the laser emitted from the impact application unit 80f to the treatment liquid layer 1000. Here, the laser emitted from the impact application unit 80f is controlled by the impact application control unit 94f such that the laser is emitted to a location having high temperature in the treatment liquid layer 1000. In other words, the thermometer control unit 93 transmits the temperature of the treatment liquid layer 1000 obtained by the thermometer 70 to the impact application control unit 94f. Based on the received temperature information, the impact application control unit 94f performs control such that a position having high temperature in the treatment liquid layer 1000 is irradiated with the laser from the impact application unit 80f.

Here, when a plurality of impact application units 80f are provided, the impact application control unit 94f controls the respective laser units 89f-1, 89f-2, 89f-3, and 89f-4. Therefore, an intensity of the laser and the like is adjusted by the impact application control unit 94f such that the laser units 89f-1, 89f-2, 89f-3, and 89f-4 can irradiate a plurality of locations having high temperature in the treatment liquid layer 1000 with a laser, respectively.

Hereinafter, a case will be described in which the substrate W has a quadrilateral shape and the temperature of the treatment liquid layer 1000 formed near four corners of the substrate W is high.

A freeze cleaning method using the substrate processing apparatus 1 of the sixth embodiment will be described. In the sixth embodiment, freeze cleaning of the substrate W is performed similarly to the first embodiment. That is, the flow of freeze cleaning using the substrate processing apparatus 1 in the sixth embodiment is similar to that shown in FIG. 10.

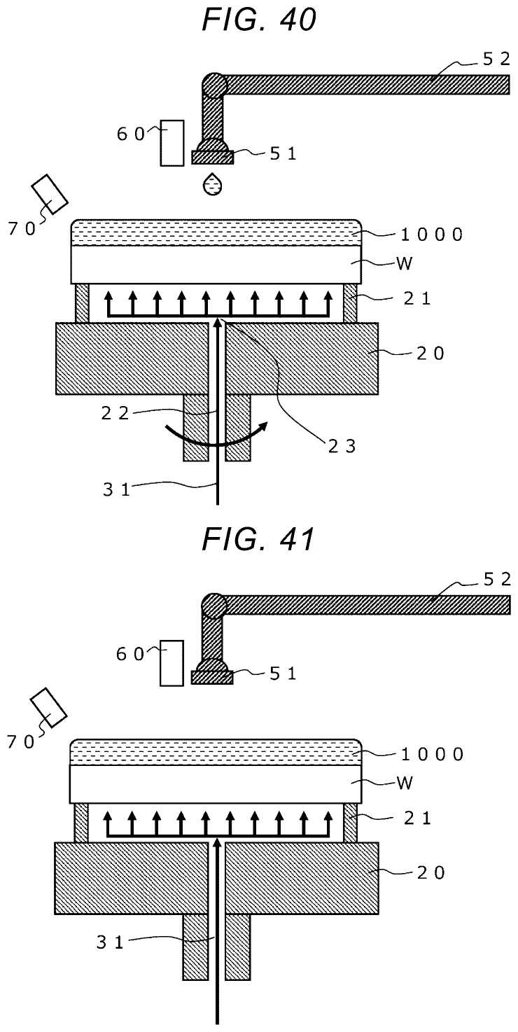

FIGS. 40 to 44 are views showing an example of procedures of a processing method of the substrate W in the sixth embodiment.

The procedures in FIGS. 40, 41 and 44 may be the same as those in FIGS. 3, 4, and 7 in the first embodiment, respectively, and will be described briefly.

First, the substrate W carried into the substrate processing apparatus 1 of the sixth embodiment is placed on the stage 20. Then, the treatment liquid is supplied onto the substrate W from the treatment liquid supply unit 50, as shown in FIG. 40. Here, the cooling medium 31 is supplied toward the surface of the substrate W opposite to the surface to be cleaned.

Next, as shown in FIG. 41, the treatment liquid layer 1000 is cooled by supplying the cooling medium 31, and the treatment liquid layer 1000 reaches a supercooled state.

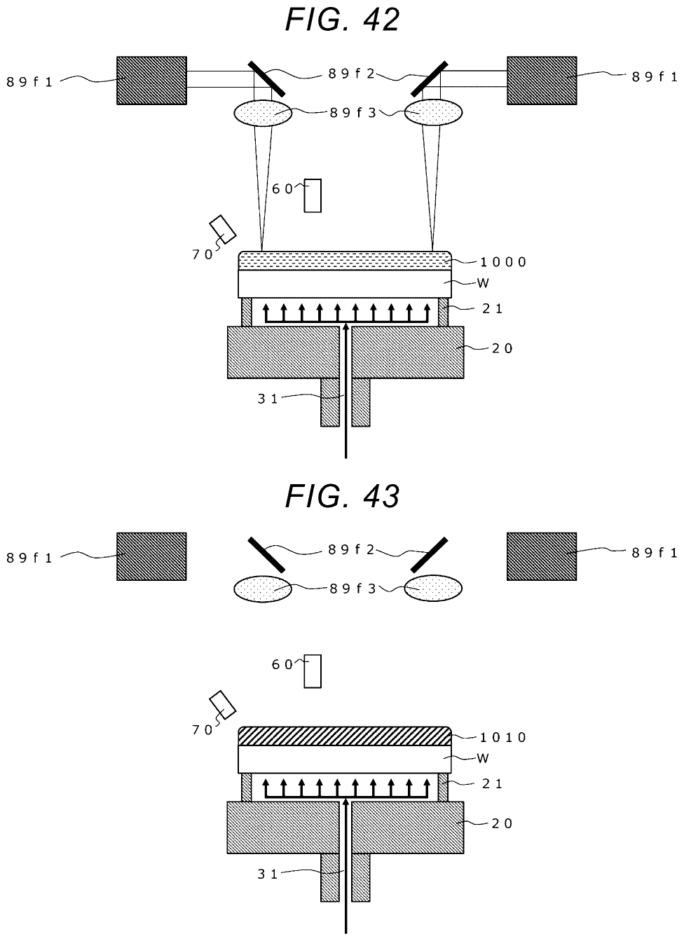

As shown in FIG. 42, when the temperature of the center of the treatment liquid layer 1000 is equal to or lower than the set temperature, the impact application unit 80f applies an impact to the location having high temperature in the treatment liquid layer 1000. Specifically, the temperature of the center of the treatment liquid layer 1000 is measured by the radiation thermometer 60, and when the temperature of the center is equal to or lower than the set temperature, the laser unit 89f emits a laser and focuses the laser. Thus, the focused laser can give an impact to the location having high temperature in the treatment liquid layer 1000.

The impact application control unit 94f controls the laser unit 89f to focus the laser on the location having high temperature in the treatment liquid layer 1000. That is, the laser units 89f-1, 89f-2, 89f-3, and 89f-4 are controlled by the impact application control unit 94f, and the respective laser units 89f irradiate a plurality of locations having high temperature in the treatment liquid layer 1000 with a laser. Thus, the four locations having high temperature in the treatment liquid layer 1000 are irradiated with the laser at approximately the same time. Control is performed such that a portion near the front surface of the treatment liquid layer 1000 (the surface opposite to the surface in contact with the substrate W) is irradiated with the laser. In other words, the treatment liquid layer 1000 is irradiated with the laser while the substrate W is not directly irradiated with the laser.

After the laser unit 89f irradiates the treatment liquid layer 1000 with the laser for a certain period of time, laser irradiation from the light source unit 89f1 is stopped.

As shown in FIG. 43, an impact is given to the treatment liquid layer 1000 by the laser emitted from the laser unit 89f. The impact causes forced freezing to occur in the treatment liquid layer 1000 at a location where the laser hits.

The laser irradiation from the laser unit 89f is performed immediately before spontaneous freezing in the treatment liquid layer 1000 occurs. Therefore, when the impact due to the laser emitted from the laser unit 89f is transmitted to the treatment liquid layer 1000 and a part of the treatment liquid layer 1000 starts to solidify, spontaneous freezing also occurs in the center of the treatment liquid layer 1000. Thus, the solidified layer 1010 is formed.

Also in the sixth embodiment, as shown in FIGS. 8 and 9, spontaneous freezing occurs in the center of the treatment liquid layer 1000, and forced freezing occurs at four end portions of the treatment liquid layer 1000 due to laser irradiation from the laser unit 89f.

By the laser irradiation from the laser units 89f-1, 89f-2, 89f-3, and 89f-4, the starting points of freezing 1030A, 1030B, 1030C, and 1030D occur at four end portions of the treatment liquid layer 1000, and forced freezing starts. Since forced freezing occurs immediately before spontaneous freezing occurs, spontaneous freezing occurs after forced freezing occurs. Spontaneous freezing occurs from the starting point of freezing 1040 which is the center of the treatment liquid layer 1000 where the temperature is lowest. The treatment liquid layer 1000 solidifies from the plurality of starting points of freezing.

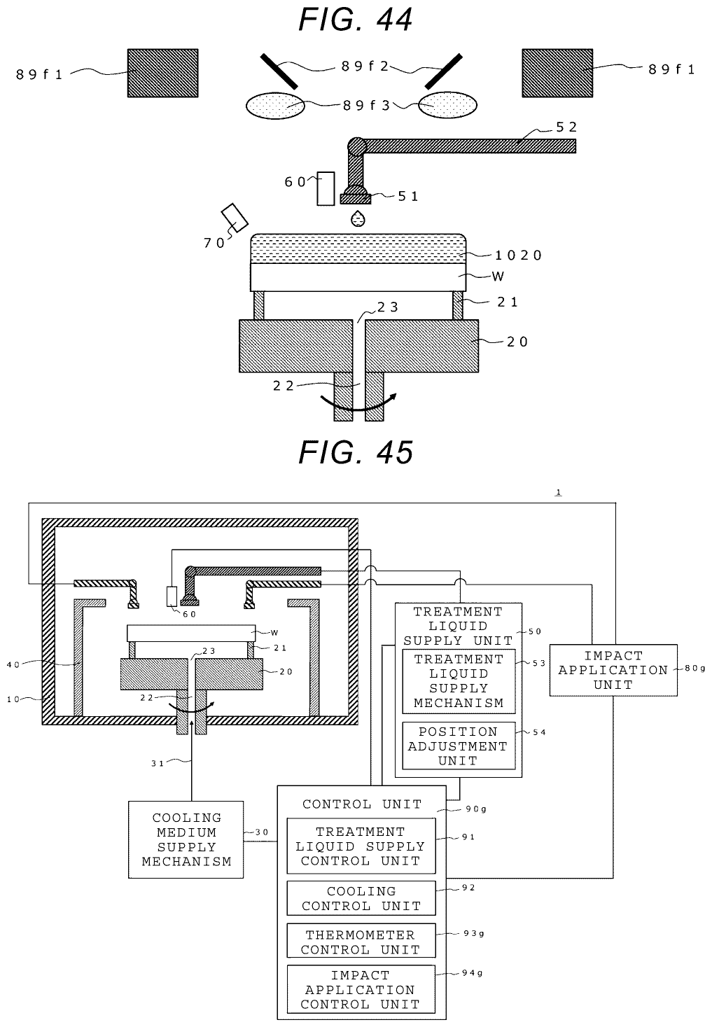

After the treatment liquid layer 1000 solidifies, as shown in FIG. 44, the treatment liquid is supplied onto the solidified layer 1010 similarly to the first embodiment, and the solidified layer 1010 thaws. Thus, the foreign substance that moved upward on the surface to be cleaned of the substrate W is washed away and removed by the treatment liquid.

As shown in FIGS. 8 and 9, also in the sixth embodiment, solidification is considered to progress radially from the starting points of freezing 1030 and 1040.

That is, according to the substrate processing apparatus 1 and the substrate processing method of the sixth embodiment, the same effects as those of the first embodiment can be achieved.

Similar to the fifth embodiment, according to the configuration of the sixth embodiment, a foreign substance adhered to the impact application unit 80f and liquid generated by condensation or the like can be prevented from dropping onto or adhering to the substrate W and the treatment liquid layer 1000.

The laser emitted from the laser unit 89f may be controlled by the impact application control unit 94f. Here, strength of the impact applied to the treatment liquid layer 1000 can be changed by changing the intensity of the laser output from the light source unit 89f1.

(Seventh Embodiment) FIG. 45 is a cross-sectional view schematically showing an example of a configuration of a substrate processing apparatus 1 according to a seventh embodiment. The substrate processing apparatus 1 includes the chamber 10, the stage 20, the cooling medium supply mechanism 30, the cleaning cup 40, the treatment liquid supply unit 50, the radiation thermometer 60, an impact application unit 80g, and a control unit 90g. In the present embodiment, a case will be described in which the control unit controls the temperature of the substrate W and the treatment liquid layer 1000 formed on the substrate W.

Since the chamber 10, the stage 20, the cooling medium supply mechanism 30, the cleaning cup 40, the treatment liquid supply unit 50, and the radiation thermometer 60 may be similar to those in the first embodiment, description thereof will be omitted. The impact application unit 80g may be any one of the impact application units 80a to 80f in the first to sixth embodiments.

In the present embodiment, temperature distribution information on the substrate W and the treatment liquid layer is recorded in hardware, software, or the like. For example, a temperature distribution of the substrate W and the treatment liquid layer 1000 may be controlled by an impact application control unit 94g, which will be described later.

The control unit 90g controls the overall operation of the substrate processing apparatus 1 according to a recipe. The control unit 90g includes the treatment liquid supply control unit 91, the cooling control unit 92, a thermometer control unit 93g, and the impact application control unit 94g.

The treatment liquid supply control unit 91 and the cooling control unit 92 may be the same as those in the first embodiment, and thus description thereof will be omitted.

The thermometer control unit 93g controls the radiation thermometer 60 which measures the temperature of the treatment liquid layer 1000. The thermometer control unit 93g receives information on the temperature of the treatment liquid layer 1000 measured by the radiation thermometer 60, and displays the temperature distribution of the treatment liquid layer 1000 on a display unit (not shown) or the like. The received temperature information can be transmitted to the impact application control unit 94g.

The impact application control unit 94g controls an impact from the impact application unit 80g and a position to which the impact is applied. The impact application control unit 94g determines a timing and a position of applying an impact to the treatment liquid layer 1000 based on the temperature information on the treatment liquid layer 1000 from the thermometer control unit 93g. In other words, when the radiation thermometer 60 detects that the temperature at the center of the treatment liquid layer 1000 is a temperature immediately before the treatment liquid layer 1000 spontaneously freezes, the impact application control unit 94g controls the impact application unit 80g to apply an impact to a set location of the treatment liquid layer 1000. The set location may be, for example, a location having high temperature in the treatment liquid layer 1000 when the center reaches the set temperature.

The impact application control unit 94g can store information on temperature change over time in the treatment liquid layer 1000, a temperature distribution of the treatment liquid layer, and the like. The impact application control unit 94g can preset a position above the treatment liquid layer 1000 at which the impact application unit 80g is provided and a magnitude of impact to be applied immediately before the treatment liquid layer 1000 spontaneously freezes.

Here, when the substrate W has a quadrilateral shape and the cooling medium 31 from the cooling medium supply mechanism 30 is supplied to the center of the rear surface of the substrate W, the locations having high temperature in the treatment liquid layer 1000 formed on the substrate W are likely to be near four corners. Here, the impact application control unit 94g sets locations where the impact is to be applied to be near the four corners of the substrate W. Then, when the treatment liquid layer 1000 reaches the set temperature (the temperature immediately before the treatment liquid layer 1000 spontaneously freezes), the impact application control unit 94g drives the impact application unit 80g to the set locations in the treatment liquid layer 1000, that is, the locations having high temperature.

Even when the shape of the substrate W or the supply position of the cooling medium 31 is not limited, it is possible for the impact application control unit 94g to perform freeze cleaning on a plurality of substrates W continuously, and store information such as temperature change over time in the treatment liquid layer 1000 and a temperature distribution in the treatment liquid layer 1000. Alternatively, it is also possible for the impact application control unit 94g to preset locations where an impact is to be applied when the center of the treatment liquid layer 1000 reaches the set temperature. Here, for example, the impact application control unit 94g presets locations where the impact is to be applied to be near the four corners of the substrate W, and when the center of the treatment liquid layer 1000 is equal to or lower than the set temperature, the impact application control unit 94g drives the impact application unit 80g to the set location in the treatment liquid layer 1000. Then, an impact is applied from the impact application unit 80g to a preset location in the treatment liquid layer 1000.

The impact from the impact application unit 80g to the treatment liquid layer 1000 is applied immediately before spontaneous freezing occurs. Therefore, when a portion of the treatment liquid layer 1000 starts to be forcedly frozen, spontaneous freezing also occurs in the center of the treatment liquid layer 1000. Thus, the treatment liquid layer 1000 solidifies from the plurality of starting points of freezing.

After the treatment liquid layer 1000 solidifies, the treatment liquid is supplied to the solidified treatment liquid layer 1000 similarly to the first embodiment, and the solidified treatment liquid layer 1000 thaws. Thus, the foreign substance that moved upward on the surface to be cleaned of the substrate W is washed away and removed by the treatment liquid.

Also in the present embodiment, similarly to the first to sixth embodiments, an impact is applied to a set location in the treatment liquid layer 1000 at the timing when spontaneous freezing occurs, and forced freezing is also performed. Therefore, even in a location far from the location of spontaneous freezing and having high temperature, the foreign substance is likely to receive an upward force, and the removal rate of the foreign substance on the substrate W is improved.

Since temperature distribution measurement using a thermometer is not performed, the overall device configuration and operation control can be simplified.

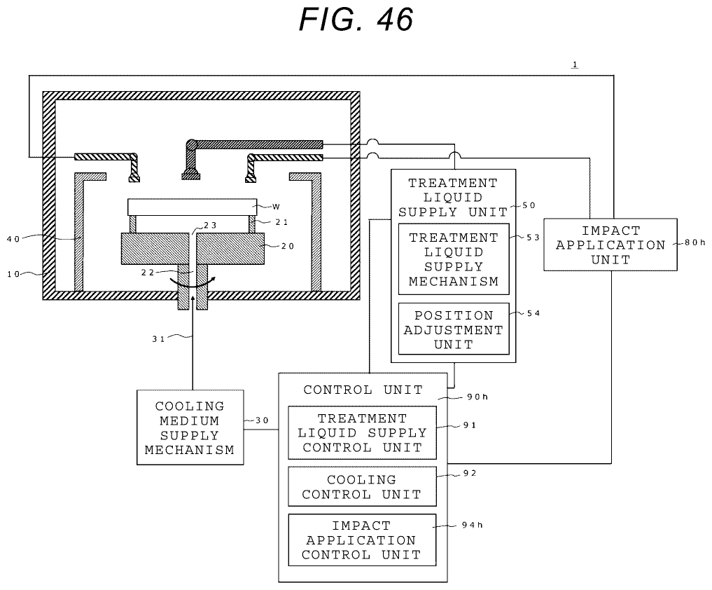

(Eighth Embodiment) FIG. 46 is a cross-sectional view schematically showing an example of a configuration of a substrate processing apparatus 1 according to an eighth embodiment. The substrate processing apparatus 1 includes the chamber 10, the stage 20, the cooling medium supply mechanism 30, the cleaning cup 40, the treatment liquid supply unit 50, an impact application unit 80h, and a control unit 90h. In the present embodiment, a case will be described in which the control unit 90h controls the temperature of the substrate W and the treatment liquid layer 1000 formed on the substrate.

Since the chamber 10, the stage 20, the cooling medium supply mechanism 30, the cleaning cup 40, and the treatment liquid supply unit 50 may be similar to those in the first embodiment, description thereof will be omitted. The impact application unit 80h may be any one of the impact application units 80a to 80f in the first to sixth embodiments.

In the present embodiment, temperature distribution information on the substrate W and the treatment liquid layer is recorded in hardware, software, or the like. For example, the temperature distribution of the substrate W and the treatment liquid layer 1000 may be controlled by an impact application control unit 94h, which will be described later.

The control unit 90h controls the overall operation of the substrate processing apparatus 1 according to a recipe. The control unit 90h includes the treatment liquid supply control unit 91, the cooling control unit 92, and the impact application control unit 94h.

The treatment liquid supply control unit 91 and the cooling control unit 92 may be the same as those in the first embodiment, and thus description thereof will be omitted.

The impact application control unit 94h determines a timing for applying an impact to the treatment liquid layer 1000 and a position at which the impact is to be applied. In other words, the timing at which the temperature of the center of the treatment liquid layer 1000 reaches a temperature immediately before the treatment liquid layer 1000 spontaneously freezes is preset. Then, when the timing is reached, the impact application control unit 94h controls the impact application unit 80h to apply an impact to set locations in the treatment liquid layer 1000.

The impact application control unit 94h can store information such as temperature change over time in the treatment liquid layer 1000 and the temperature distribution of the treatment liquid layer. Therefore, the time from when the treatment liquid layer 1000 is formed on the substrate W and starts to be cooled by the cooling medium 31 until the center of the treatment liquid layer 1000 becomes equal to or lower than a set temperature can be calculated in advance. The impact application control unit 94h can preset a position above the treatment liquid layer 1000 at which the impact application unit 80h is provided and a magnitude of impact to be applied immediately before the treatment liquid layer 1000 spontaneously freezes.

Here, when the substrate W has a quadrilateral shape and the cooling medium 31 from the cooling medium supply mechanism 30 is supplied to the center of the rear surface of the substrate W, the locations having high temperature in the treatment liquid layer 1000 formed on the substrate W are likely to be near four corners. Here, the impact application control unit 94h sets a timing at which the center of the treatment liquid layer 1000 reaches the set temperature and locations at which the impact is applied to the substrate W to be near the four corners. Then, at a timing that the treatment liquid layer 1000 is estimated to be equal to or lower than the set temperature, the impact application control unit 94h controls the impact application unit 80h to drive to the locations having high temperature in the treatment liquid layer 1000, thereby applying an impact.

Even when the substrate W is not quadrilateral in shape or the cooling medium 31 is not supplied to the center of the substrate W, the impact application control unit 94h performs freeze cleaning on a plurality of substrates W continuously, for example, to perform freeze cleaning a plurality of times. Thus, it is possible to store information such as temperature change over time in the treatment liquid layer 1000 and a temperature distribution of the treatment liquid layer 1000, and use the information to estimate the next freeze cleaning. The impact application control unit 94h can also preset a location where an impact is to be applied. Therefore, for example, the impact application control unit 94h presets the locations where the impact is to be applied to be near the four corners of the substrate W, and when a cooling time for the substrate W and the treatment liquid layer 1000 reaches a set period of time, the impact application control unit 94h drives the impact application unit 80h to the locations having high temperature in the treatment liquid layer 1000. Then, an impact is applied from the impact application unit 80h to the preset location in the treatment liquid layer 1000. The preset location may be, for example, a location having high temperature in the treatment liquid layer 1000 when the temperature of the center is equal to or lower than the set temperature.

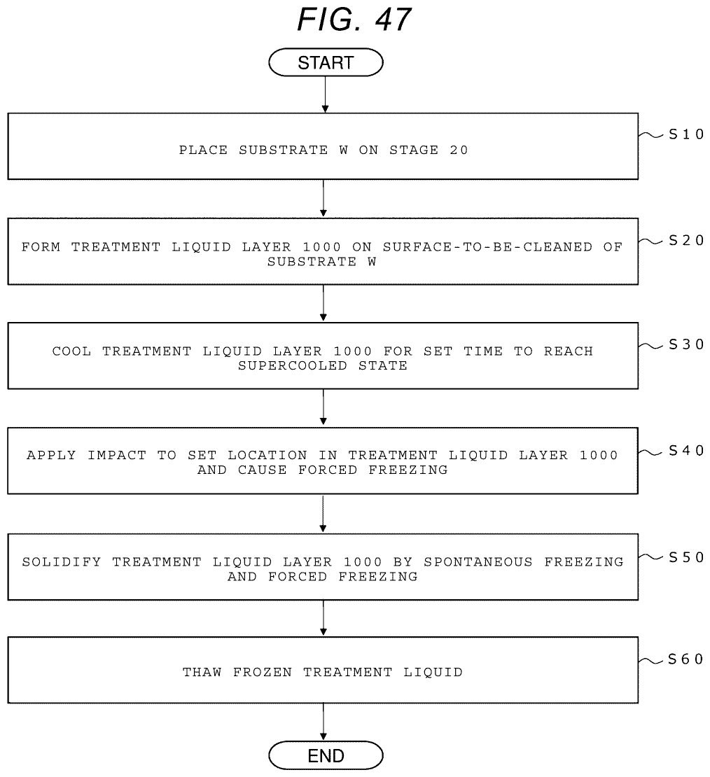

FIG. 47 is a flowchart showing an example of a procedure of freeze cleaning in the eighth embodiment.

First, the substrate W is carried into the chamber 10 of the substrate processing apparatus 1, and the substrate W to be processed is placed on the stage 20 (S10). Here, the substrate W is placed with the surface to be cleaned facing up. Foreign substance is adhered to the surface to be cleaned of the substrate W.

Next, the treatment liquid layer 1000 is formed on the upper surface of the substrate W (S20). The treatment liquid layer 1000 is formed on the surface to be cleaned of the substrate W by supplying the treatment liquid from the treatment liquid supply unit 50. Here, the treatment liquid layer 1000 may be formed by, for example, a spin coating method. When the treatment liquid layer 1000 is formed on the surface to be cleaned of the substrate W, the cooling medium 31 having a temperature lower than the freezing point of the treatment liquid may be supplied to the rear surface of the substrate W, that is, the surface opposite to the surface to be cleaned.

During a set time, the treatment liquid layer 1000 is cooled by supplying the cooling medium 31 to the rear surface of the substrate W, and the treatment liquid layer 1000 reaches a supercooled state (S30). Here, the stage 20 may be rotated around the through hole 22 as an axis, or rotation may be stopped. The cooling medium is, for example, a gas such as nitrogen gas cooled to a temperature lower than the freezing point of the treatment liquid, or a liquid such as liquid nitrogen or liquid fluorocarbon.

The control unit 90h presets the time for cooling the substrate W and the treatment liquid layer 1000. The time for cooling is controlled by, for example, the impact application control unit 94h. The set time is the time from start of the cooling of the treatment liquid layer 1000 until the temperature reaches a temperature immediately before spontaneous freezing.

After the set time is elapsed, the impact application control unit 94h controls the impact application unit 80h to apply an impact to the treatment liquid layer 1000, thereby causing forced freezing (S40). Here, the impact is applied to the preset location in the treatment liquid layer 1000. Specifically, for example, the impact application control unit 94h stores or sets a location having high temperature in the treatment liquid layer 1000. Accordingly, after the substrate W and the treatment liquid layer are cooled for a certain period of time, the impact application control unit 94h controls the impact application unit 80h to apply an impact to the preset location in the treatment liquid layer 1000.

When the treatment liquid layer 1000 receives an impact from the impact application unit 80h, forced freezing starts from the location where the impact is applied. Impact is applied to the treatment liquid layer 1000 immediately before spontaneous freezing in the treatment liquid layer 1000 occurs. Therefore, when a portion of the treatment liquid layer 1000 starts to be forcedly frozen, spontaneous freezing also occurs in the center of the treatment liquid layer 1000, and the treatment liquid layer 1000 solidifies (S50).

Next, the supply of the cooling medium 31 to the lower surface of the substrate W is stopped, and the stage 20 is rotated with the through hole 22 as an axis while the treatment liquid is supplied from the treatment liquid supply unit 50 to thaw the treatment liquid that is solidified on the substrate W (S60). Here, the treatment liquid to be supplied may be at room temperature.

By executing the above flow, foreign substance on the surface to be cleaned of the substrate W and covered by the treatment liquid layer 1000 is separated from the surface to be cleaned of the substrate W by an upward moving force and is removed.

Also in the present embodiment, similarly to the first to seventh embodiments, an impact is applied to the set location in the treatment liquid layer 1000 at the timing when spontaneous freezing occurs, and forced freezing is performed. Therefore, even in a location far from the location of spontaneous freezing and having high temperature, the foreign substance is likely to receive an upward force, and the removal rate of the foreign substance on the substrate W is improved.

Since temperature measurement using a radiation thermometer and temperature distribution measurement using a thermometer are not performed, the overall device configuration and operation control can be simplified.

(Ninth Embodiment) A substrate W used in the present embodiment has a circular shape. The configuration of the substrate processing apparatus 1 may be similar to that in the first embodiment.

First, the substrate W is carried into the substrate processing apparatus 1 and placed on the stage 20. The substrate W placed on the stage 20 is fixed such that the placement position does not shift when the stage 20 rotates. The cooling medium 31 from the cooling medium supply mechanism 30 is supplied to, for example, a center of circle of the rear surface of the circular substrate W. The center of circle is the center of the substrate W, and refers to a center of circle of the substrate W and vicinity thereof.

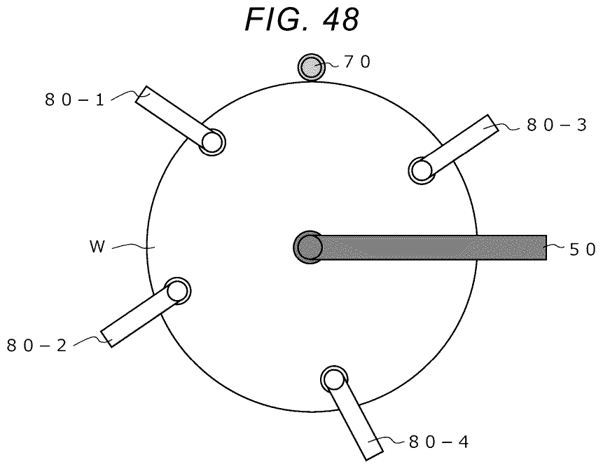

FIG. 48 is a top view schematically showing an example of a configuration of the substrate processing apparatus 1 according to the ninth embodiment. In the ninth embodiment, the substrate processing apparatus 1 and a cleaning flow of the substrate W are similar to those in the first embodiment.

After the treatment liquid layer 1000 is formed on the front surface (surface to be cleaned) of the substrate W by supplying the treatment liquid from the treatment liquid supply unit 50, the temperature of the treatment liquid layer 1000 is measured by the radiation thermometer 60 and the thermometer 70. Here, the radiation thermometer 60 and the thermometer 70 may not be provided, and temperature distribution information on the substrate W and the treatment liquid layer may be recorded in hardware, software, or the like. When recording the temperature distribution information on the substrate W and the treatment liquid layer 1000 in hardware, software, or the like, a timing and a position at which an impact is applied to the treatment liquid layer 1000 may be determined and set in advance.

Hereinafter, a case will be described in which the substrate processing apparatus 1 includes the radiation thermometer 60 and the thermometer 70 and measures the temperatures of the substrate W and the treatment liquid layer 1000.

While the cooling medium 31 is supplied toward the rear surface of the substrate W, a treatment liquid layer 1000 is formed on the substrate W. Here, the cooling medium 31 is supplied toward the rear surface of the substrate W, such that the treatment liquid layer 1000 reaches a supercooled state.

When the temperature of the center of the treatment liquid layer 1000 is equal to or lower than the set temperature, the impact application unit 80 applies an impact to the location having high temperature in the treatment liquid layer 1000. Here, the thermometer 70 can measure the location having high temperature in the treatment liquid layer 1000, and the control unit determines the location in the treatment liquid layer 1000 to which the impact is to be applied based on the measurement result of the thermometer 70.

In FIG. 48, four locations having high temperature are specified on the substrate W and in the treatment liquid layer 1000, and the impact application units 80 are disposed above the locations.

When the impact from the impact application unit 80 is transmitted to the treatment liquid layer 1000, a part of the treatment liquid layer 1000 starts to solidify. When forced freezing in the treatment liquid layer 1000 due to such an impact starts, spontaneous freezing also occurs in the center of the treatment liquid layer 1000. Accordingly, the treatment liquid layer 1000 solidifies. As forced freezing is caused immediately before spontaneous freezing occurs, spontaneous freezing also occurs after forced freezing occurs, such that the treatment liquid layer 1000 solidifies from the plurality of starting points of freezing.

After the treatment liquid layer 1000 solidifies, the treatment liquid is supplied onto the solidified treatment liquid layer 1000 similarly to the first embodiment, and the solidified treatment liquid layer 1000 thaws. Thus, the foreign substance that moved upward on the surface to be cleaned of the substrate W is washed away and removed by the treatment liquid.

As described above, even when the substrate W is circular, a location having high temperature or any location in the substrate W and the treatment liquid layer 1000 is specified and an impact is applied thereto, such that the treatment liquid layer 1000 can be solidified from a plurality of starting points of freezing. Therefore, the same effects as in the first embodiment can be achieved.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A substrate processing apparatus comprising:
a substrate holder configured to hold a substrate;
a treatment liquid supplier configured to supply treatment liquid onto a surface of the substrate to be cleaned;
a cooler configured to that supplies a cooling medium for cooling the substrate;
an impactor configured to apply an impact to a treatment liquid layer formed on the surface of the substrate to be cleaned; and
a controller configured to control the treatment liquid supplier, the cooler, and the impactor, the controller being configured to
control the cooler to cool the treatment liquid layer to a temperature lower than a freezing point to bring the treatment liquid layer to a supercooled state, and
control the impactor to apply an impact to a starting point of forced freezing located away from a starting point of spontaneous freezing in the treatment liquid layer, when a temperature of the treatment liquid layer reaches a set temperature that is lower than the freezing point and higher than a temperature at which spontaneous freezing occurs.

2. The substrate processing apparatus according to claim 1, further comprising:
a first thermometer configured to measure a temperature of the treatment liquid layer; and
a second thermometer configured to measure a temperature distribution of the treatment liquid layer, wherein
the controller is configured to
determine whether the treatment liquid layer reaches a temperature equal to or lower than the set temperature based on the temperature of the treatment liquid layer measured by the first thermometer, and
determine, as the starting point of forced freezing, a portion of the treatment liquid layer having a higher temperature than another portion of the treatment liquid layer, based on the temperature distribution of the treatment liquid layer measured by the second thermometer.

3. The substrate processing apparatus according to claim 2, wherein
the first thermometer is configured to measure the temperature of the treatment liquid layer by measuring a temperature of the substrate on which the temperature of the treatment liquid layer is reflected, and
the second thermometer is configured to measure the temperature distribution of the treatment liquid layer by measuring a temperature distribution of the substrate on which the temperature distribution of the treatment liquid layer is reflected.

4. The substrate processing apparatus according to claim 1, wherein
the impactor comprises a plurality of impactors, and
the controller is configured to control the plurality of impactors to simultaneously apply an impact to a plurality of the starting points of forced freezing in the treatment liquid layer, respectively.

5. The substrate processing apparatus according to claim 1, wherein
the cooler is configured to supply a cooling medium toward a center of a rear surface of the surface of the substrate to be cleaned,
the starting point of spontaneous freezing is a first portion of the treatment liquid layer, the first portion being located on a center of the substrate, and
the starting point of forced freezing is a second portion of the treatment liquid layer, the second portion being located on an outer periphery of the substrate.

6. The substrate processing apparatus according to claim 5, wherein
the substrate has a quadrilateral shape, and
the starting point of forced freezing is provided in plurality,
the plurality of starting points of forced freezing are portions of the treatment liquid layer, the portions being located on corners of the outer periphery of the substrate.

7. The substrate processing apparatus according to claim 1, wherein
when a temperature of the treatment liquid layer reaches a temperature equal to or lower than the set temperature, forced freezing starts at the starting point of forced freezing in the treatment liquid layer, and spontaneous freezing starts thereafter at the starting point of spontaneous freezing in the treatment liquid layer.

8. The substrate processing apparatus according to claim 7, wherein
the substrate is configured to permit removal of foreign matter that is moved upward from the surface of the substrate to be cleaned by the forced freezing and the spontaneous freezing.

9. The substrate processing apparatus according to claim 1, wherein
the impactor includes a liquid supplier configured to dispense liquid onto the treatment liquid layer, and
the controller is configured to control the impactor to apply an impact onto the starting point of forced freezing in the treatment liquid layer by dispensing liquid from the liquid supplier.

10. The substrate processing apparatus according to claim 1, wherein
the impactor includes a gas supplier configured to supply gas cooled to a temperature lower than a freezing point of the treatment liquid onto the treatment liquid layer, and
the controller is configured to control the impactor to blow the gas from the gas supplier onto the starting point of forced freezing in the treatment liquid layer.

11. The substrate processing apparatus according to claim 1, wherein
the impactor includes a contact portion configured to contact the treatment liquid layer, and
the controller is configured to control the impactor such that the contact portion contacts the starting point of forced freezing in the treatment liquid layer.

12. The substrate processing apparatus according to claim 1, wherein
the impactor includes a contact portion configured to contact the treatment liquid layer and to generate ultrasonic waves, and
the controller is configured to control the impactor such that the contact portion generating the ultrasonic waves contacts the starting point of forced freezing in the treatment liquid layer.

13. The substrate processing apparatus according to claim 1, wherein
the impactor includes an ultrasonic oscillator configured to apply ultrasonic waves to the treatment liquid layer, and
the controller is configured to control the impactor to generate the ultrasonic waves onto the starting point of forced freezing in the treatment liquid layer.

14. The substrate processing apparatus according to claim 1, wherein
the impactor includes a laser unit configured to irradiate the treatment liquid layer with a laser, and
the controller is configured to control the impactor such that the starting point of forced freezing in the treatment liquid layer is irradiated with the laser.

15. The substrate processing apparatus according to claim 1, further comprising:
a thermometer configured to measure the temperature of the treatment liquid layer, wherein
the controller is configured to
determine whether the treatment liquid layer reaches a temperature equal to or lower than the set temperature based on the temperature of the treatment liquid layer measured by the thermometer,
store information relating to a temperature distribution over time in the treatment liquid layer, and
determine a portion of the treatment liquid layer having a higher temperature than another portion of the treatment liquid layer as the starting point of forced freezing based on the information.

16. The substrate processing apparatus according to claim 1, wherein the controller is configured to
store information relating to a temperature change and a temperature distribution over time in the treatment liquid layer, and
determine, based on the information, whether the treatment liquid layer reaches a temperature equal to or lower than the set temperature, and determine a portion of the treatment liquid layer having a higher temperature than another portion of the treatment liquid layer as the starting point of forced freezing.

17. A substrate processing method comprising:
forming a treatment liquid layer by supplying a treatment liquid onto a surface of a substrate to be cleaned;
cooling the treatment liquid layer formed on the surface of the substrate to be cleaned to a temperature lower than a freezing point to bring the treatment liquid layer to a supercooled state;
solidifying the treatment liquid layer to form a solidified layer by applying an impact to a starting point of forced freezing located away from a starting point of spontaneous freezing in the treatment liquid layer, when a temperature of the treatment liquid layer reaches a set temperature that is lower than the freezing point and higher than a temperature at which spontaneous freezing occurs; and
supplying the treatment liquid onto the solidified layer to thaw the solidified layer.

18. The method for processing a substrate according to claim 17, further comprising
determining whether the treatment liquid layer reaches a temperature equal to or lower than the set temperature based on the temperature of the treatment liquid layer, and determining, as the starting point of forced freezing, a portion of the treatment liquid layer having a higher temperature than another portion of the treatment liquid layer, based on a temperature distribution of the treatment liquid layer.

19. The method for processing a substrate according to claim 17, wherein
a plurality of the starting points of forced freezing are provided.

20. The method for processing a substrate according to claim 17, wherein
the substrate has a quadrilateral shape,
the treatment liquid is supplied toward a center of a rear surface of the surface of the substrate to be cleaned,
the starting point of spontaneous freezing is a portion of the treatment liquid layer formed on the surface of the substrate to be cleaned, the portion being located on a center of the substrate, and
the starting point of forced freezing is portions in the treatment liquid layer, the portions being located on corners of an outer periphery of the substrate.
